(19) United States
(12) Patent Application Publication
(10) Pub. No.: US 2026/0039351 A1
(43) Pub. Date: Feb. 5, 2026

(54) TRIGGERING BEAM REPORTING BASED ON EVENT DETECTION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/284,531

(22) Filed: Jul. 29, 2025

Related U.S. Application Data
(60) Provisional application No. 63/679,448, filed on Aug. 5, 2024.
(60) Provisional application No. 63/682,165, filed on Aug. 12, 2024.

(51) Int. Cl. H04B 7/06; H04B 17/318

(52) U.S. Cl. CPC H04B 7/0626; H04B 17/328

(57) ABSTRACT

Methods and apparatuses for triggering beam reporting based on event detection. A method performed by a user equipment (UE) includes receiving one or more transmission configuration indication (TCI) states, receiving information related to an event in a channel state information (CSI) report configuration for UE-initiated (UEI) reporting, and determining a first reference signal (RS) resource based on the one or more TCI states and the information. The method further includes determining one or more second RS resources based on the CSI report configuration, monitoring transmission occasions (TOs) of the first RS resource and the one or more second RS resources, and determining the event based on layer-1 reference signal received powers (L1-RSRPs) of the TOs and the information.

### CROSS-REFERENCE TO RELATED AND CLAIM OF PRIORITY

The present application claims priority under 35 U.S.C. § 119(e) to U.S. Provisional Patent Application No. 63/679,448 filed on Aug. 5, 2024 and U.S. Provisional Patent Application No. 63/682,165 filed on Aug. 12, 2024, which are hereby incorporated by reference in their entirety.

### TECHNICAL FIELD

The present disclosure relates generally to wireless communication systems and, more specifically, the present disclosure relates to methods and apparatuses for triggering beam reporting based on event detection.

### BACKGROUND

Wireless communication has been one of the most successful innovations in modem history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to triggering beam reporting based on event detection.

In one embodiment, a user equipment (UE) is provided. The UE includes a transceiver configured to receive one or more transmission configuration indication (TCI) states and receive information related to an event in a channel state information (CSI) report configuration for UE-initiated (UEI) reporting. The UE further includes a processor operably coupled with the transceiver. The processor is configured to determine a first reference signal (RS) resource based on the one or more TCI states and the information and determine one or more second RS resources based on the CSI report configuration. The transceiver is further configured to monitor transmission occasions (TOs) of the first RS resource and the one or more second RS resources. The processor is further configured to determine the event based on layer-1 reference signal received powers (L1-RSRPs) of the TOs and the information.

In another embodiment, a base station (BS) is provided. The BS includes a processor and a transceiver operably coupled with the transceiver. The processor is configured to transmit one or more TCI states, transmit information related to an event in a CSI report configuration for UEI reporting, and transmit on TOs of a first RS resource and one or more second RS resources. The one or more TCI states and the information indicate the first RS resource. The CSI report configuration indicate the one or more second RS resources. The event is based on L1-RSRPs of the TOs and the information.

In yet another embodiment, a method performed by a UE is provided. The method includes receiving one or more TCI states, receiving information related to an event in a CSI report configuration for UEI reporting, and determining a first RS resource based on the one or more TCI states and the information. The method further includes determining one or more second RS resources based on the CSI report configuration, monitoring TOs of the first RS resource and the one or more second RS resources, and determining the event based on L1-RSRPs of the TOs and the information.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate examples of UE-initiated (UEI) report format/content(s)/quantity(s) according to embodiments of the present disclosure;

FIGS. 8A, 8B, and 8C illustrate examples of event evaluation procedure(s) for UEI beam reporting according to embodiments of the present disclosure;

FIG. 9 illustrates an example of determining time window(s) for event evaluation for UEI beam reporting according to embodiments of the present disclosure; and

FIG. 10 illustrates an example method performed by a UE in a wireless communication system according to embodiments of the present disclosure.

### DETAILED DESCRIPTION

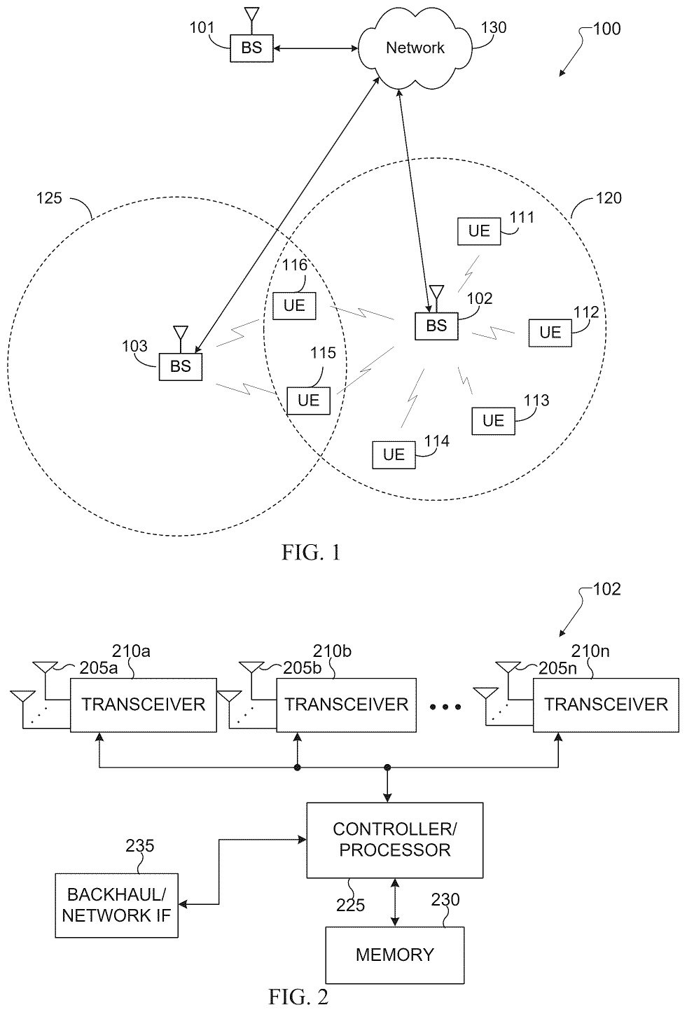

FIGS. 1-10, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1] 3GPP TS 38.211 v16.1.0, “NR; Physical channels and modulation;” [REF 2]3GPP TS 38.212 v16.1.0, “NR; Multiplexing and Channel coding;” [REF 3]3GPP TS 38.213 v16.1.0, “NR; Physical Layer Procedures for Control;” [REF 4]3GPP TS 38.214 v16.1.0, “NR; Physical Layer Procedures for Data;” [REF 5]3GPP TS 38.321 v16.1.0, “NR; Medium Access Control (MAC) protocol specification;” and [REF 6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for beam reporting based on event detection. In certain embodiments, one or more of the BSs 101-103 include circuitry, programing, or a combination thereof to support triggering beam reporting based on event detection.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as supporting triggering beam reporting based on event detection. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

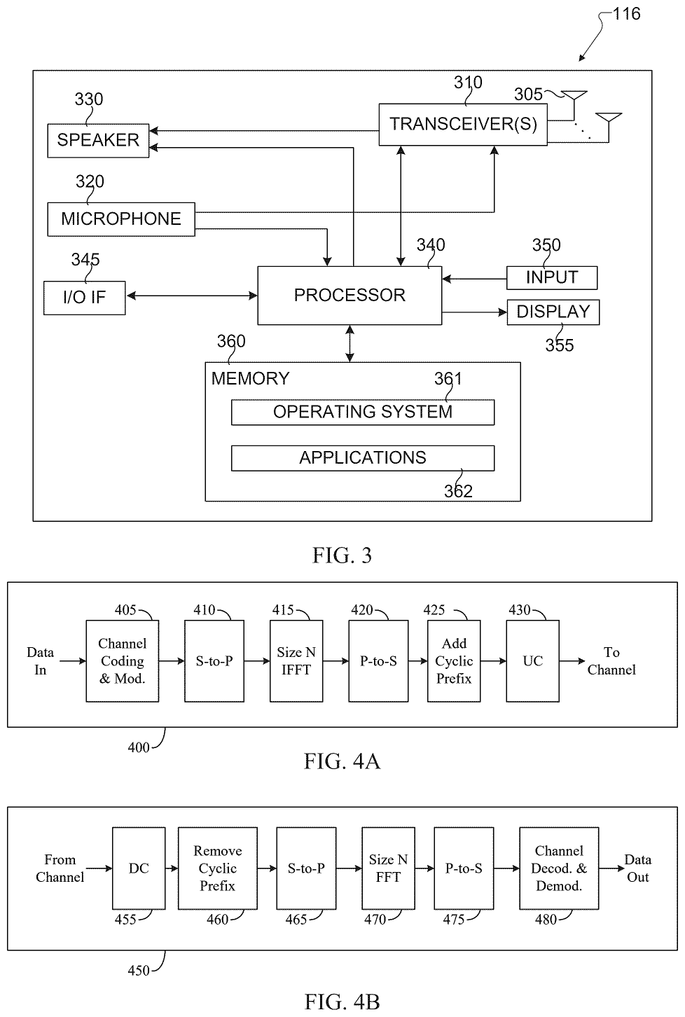

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes to perform beam reporting based on event detection as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured to support triggering beam reporting based on event detection as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

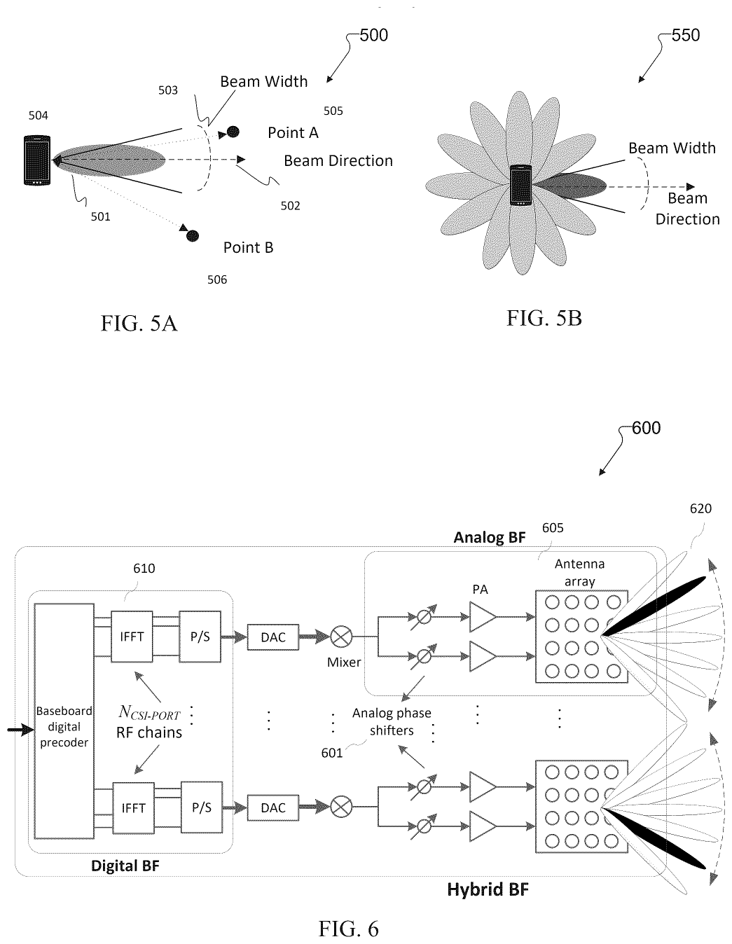

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state indication refence signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In (up to Rel.17) NR specification, the most resource-efficient reporting mechanism for a content (e.g. beam. CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE (e.g., the UE 116) knows the DL channel condition better. In this case, it is clearly beneficial if the UE can initiate its own aperiodic reporting for a content (e.g. beam. CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g. for beam report, the event can be beam failure, and for CSI, the event can be user throughput degradation or increasing retransmission rate).

The present disclosure provides various and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various report formats customized for the UE-initiated/event-driven beam reporting, and specifies different conditions or settings to apply or use different report formats. Means of detecting/declaring different events or combinations of different events, and designs of their corresponding configurations and signaling details are specified in this disclosure as well.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB (e.g., the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ, Jᵢ)}, where Iᵢ is an beam (source RS) indicator (e.g. channel quality indicator report interval (CRI), synchronization signal block resource indicator (SSBRI)) and Jᵢ is a beam metric (e.g. L1-reference signal received power (RSRP), L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (LI).
In one example, the content includes time-domain channel property (TDCP)-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-)correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (transmission configuration indication (TCI) state) TCI states (e.g. DL TCI state, UL TCI state, or unified (joint) DL/UL TCI state), or
      panel(s) (e.g. UE panels for DL reception or/and UL transmission), or
      antenna(e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ sounding reference signal (SRS) ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| | | Trigger/pre-notification | Con- |
| Event type | Type | message | tent |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/TDCP | (A) | Yes (e.g. non-CSI-related event) | No |
| | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), content- | No |
| | specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (NCB, or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of carrier waves (CWs).
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the corresponding content(s) via/in a same report/reporting instance/transmission/transmission occasion (e.g., via/in a same set of uplink resources including physical uplink control channel(s) (PUCCH(s)), PUSCH(s), MAC CE(s), physical random access channel(s) (PRACH(s)) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

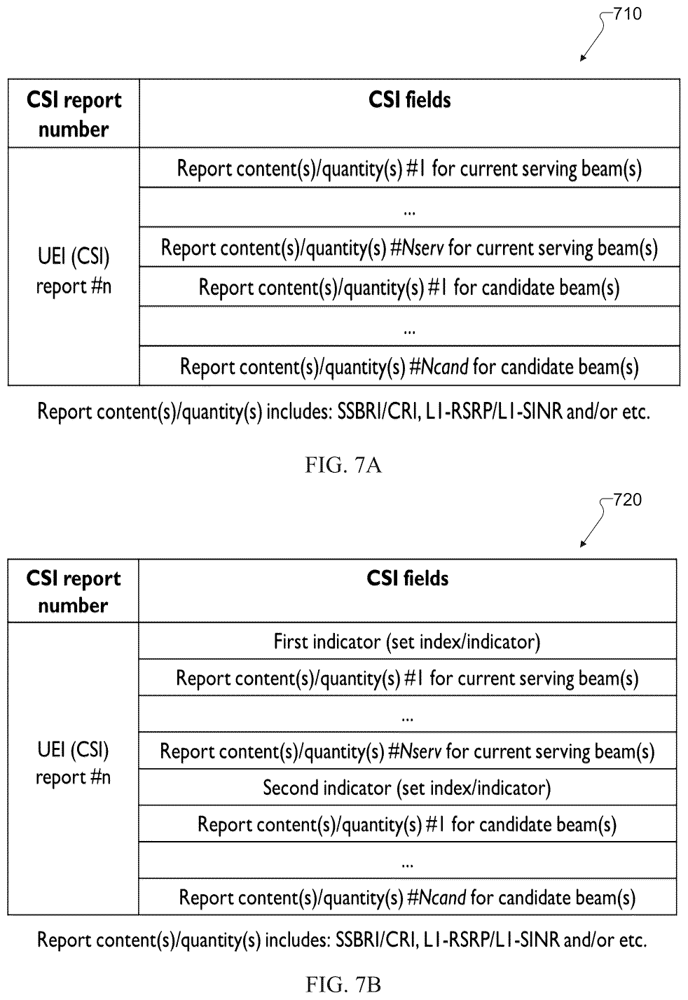

FIGS. 7A and 7B illustrate examples of UE-initiated (UEI) report format/content(s)/quantity(s) 710 and 720 according to embodiments of the present disclosure. For example, UEI report format/content(s)/quantity(s) 710 and 720 can be reported by any of the UEs 111-116 of FIG. 1. This example is for illustration only and other embodiments can be used without departing from the scope of the present disclosure.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE (e.g., the UE 116) could be provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured, the UEI report could or should comprise (1) and/or (3); otherwise, the UEI report could or should comprise (2). Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’, the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)—including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network, e.g., via higher layer RRC signaling(s)/parameter(s) and/or MAC CE command(s) and/or dynamic DCI based L1 signaling(s)—according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network (e.g., the network 130), e.g., in/by part of the UEI report including the PN message, their determination or selection or decision.
In one example, the UE could send to the network a/the PN message to indicate to the network whether or not the UEI report comprises (1), (2) and/or (3) as described herein. For instance, the PN message could be or could comprise a one-bit indicator; when/if the one-bit indicator is set to ‘0’ (or ‘1’), the UEI report comprises (1) and/or (3); otherwise, the UEI report comprises (2). Alternatively, the PN message could be or could comprise a multi-bit indicator (e.g., a two-bit indicator); when/if the two-bit indicator is set to ‘00’ (‘01’, ‘10’ or ‘11’), the UEI report comprise (1), when/if the two-bit indicator is set to ‘01’ (‘00’, ‘10’ or ‘11’), the UEI report comprises (2), and/or when/if the two-bit indicator is set to ‘10’ or ‘11’ (‘00’ or ‘01’), the UEI report comprises (3).
In another example, the PN message could be or could comprise a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
In another example, each of the report content(s)/quantity(s) including a resource indicator such as a SSBRI/CRI or a beam metric such as a L1-RSRP/L1-SINR in a UEI report could be associated with an indicator provided in the same UEI report. In this case, the indicator could be a one-bit indicator; when/if the one-bit indicator is set to ‘0’ (or ‘1’), the resource indicator (including SSBRI and/or CRI) and/or the beam metric (including L1-RSRP and/or L1-SINR) associated/corresponding to the one-bit indicator could correspond to a current serving beam, and/or when/if the one-bit indicator is set to ‘1’ (or ‘0’), the resource indicator (including SSBRI and/or CRI) and/or the beam metric (including L1-RSRP and/or L1-SINR) associated/corresponding to the one-bit indicator could correspond to a candidate beam.
In another example, each of the report content(s)/quantity(s) including a resource indicator such as a SSBRI/CRI or a beam metric such as a L1-RSRP/L1-SINR in a UEI report could be associated with an on/off indicator provided in the same UEI report. In this case, when/if the indicator is on or present in the UEI report or set to ‘on’, the resource indicator (including SSBRI and/or CRI) and/or the beam metric (including L1-RSRP and/or L1-SINR) associated/corresponding to the indicator could correspond to a current serving beam, and/or when/if the indicator is off or absent from the UEI report or set to ‘off’, the resource indicator (including SSBRI and/or CRI) and/or the beam metric (including L1-RSRP and/or L1-SINR) associated/corresponding to the indicator could correspond to a candidate beam.
In another example, for (3), position(s)/ordering(s)/CSI report number(s)/CSI report index(es)/CSI report field(s) of the report content(s)/quantity(s) including resource indicator(s) such as SSBRI(s)/CRI(s) and/or beam metric(s) such as L1-RSRP(s)/L1-SINR(s) corresponding to current serving beam(s) and/or candidate beam(s) in the UEI report(s) could be fixed/predetermined/predefined. For instance, denote the number of the report content(s)/quantity(s) including resource indicator(s) such as SSBRI(s)/CRI(s) and/or beam metric(s) such as L1-RSRP(s)/L1-SINR(s) corresponding to current serving beam(s) by Nserv, the first (or last) Nserv position(s)/ordering(s)/CSI report number(s)/CSI report index(es)/CSI report field(s) in a/the UEI report could be used to carry or convey the report content(s)/quantity(s) for the current serving beam(s), and the rest of the position(s)/ordering(s)/CSI report number(s)/CSI report index(es)/CSI report field(s) in the same UEI report could be used to carry or convey the report content(s)/quantity(s) for the candidate beam(s). Alternatively, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) by Ncand, the first (or last) Ncand position(s)/ordering(s)/CSI report number(s)/CSI report index(es)/CSI report field(s) in a/the UEI report could be used to carry or convey the report content(s)/quantity(s) for the candidate beam(s), and the rest of the position(s)/ordering(s)/CSI report number(s)/CSI report index(es)/CSI report field(s) in the same UEI report could be used to carry or convey the report content(s)/quantity(s) for the serving beam(s). One conceptual example characterizing the UEI reporting format described/specified herein in the present disclosure is presented in FIG. 7A.
In another example, for (3), a first indicator and/or a second indicator could be provided, reported, sent, comprised, included, contained or transmitted in a/the UEI report as specified herein in the present disclosure. For this design example, the first indicator could be specific/associated/corresponding to or could be used to indicate a serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure, and/or the second indicator could be specific/associated/corresponding to or could be used to indicate a candidate beam(s) RS set and/or information related to report content(s)/quantity(s) including resource indicator(s) such as SSBRI(s)/CRI(s) and/or beam metric(s) such as L1-RSRP(s)/L1-SINR(s) for one or more candidate beams according to those specified herein in the present disclosure. In particular, the first indicator could correspond to a set index/indicator for a serving beam(s) RS set denoted by s̅₀ according to those specified herein in the present disclosure—e.g., the set index/indicator for the serving beam(s) RS set, and therefore, the first indicator, could be ‘0’ (or ‘1’ or ‘2’); optionally or alternatively, the first indicator could correspond to a one-bit indicator (e.g., a one-bit set index/indicator) with ‘0’ (or ‘1’ or ‘2’) corresponding to/indicating the serving beam(s) RS set and/or information related to report content(s)/quantity(s) including resource indicator(s) such as SSBRI(s)/CRI(s) and/or beam metric(s) such as L1-RSRP(s)/L1-SINR(s) for the current serving beam(s) according to those specified herein in the present disclosure. Furthermore, the second indicator could correspond to a set index/indicator for a candidate beam(s) RS set denoted by s̅₁ according to those specified herein in the present disclosure—e.g., the set index/indicator for the candidate beam(s) RS set, and therefore, the second indicator, could be ‘1’ (or ‘0’ or ‘2’); optionally or alternatively, the second indicator could correspond to a one-bit indicator (e.g., a one-bit set index/indicator) with ‘1’ (or ‘0’ or ‘2’) corresponding to/indicating the candidate beam(s) RS set and/or information related to report content(s)/quantity(s) including resource indicator(s) such as SSBRI(s)/CRI(s) and/or beam metric(s) such as L1-RSRP(s)/L1-SINR(s) for the candidate beam(s) according to those specified herein in the present disclosure. Denote the number of the report content(s)/quantity(s) including resource indicator(s) such as SSBRI(s)/CRI(s) and/or beam metric(s) such as L1-RSRP(s)/L1-SINR(s) corresponding to current serving beam(s) in a/the UEI report by Nserv, the first Nserv CSI fields in the UEI report following the CSI field that provides, carries or conveys the first indicator could be used to provide, carry or convey the Nserv report content(s)/quantity(s) specific to/for the current serving beam(s). In addition, denote the number of the report content(s)/quantity(s) including resource indicator(s) such as SSBRI(s)/CRI(s) and/or beam metric(s) such as L1-RSRP(s)/L1-SINR(s) corresponding to candidate beam(s) in a/the UEI report by Ncand, the first Ncand CSI fields in the UEI report following the CSI field that provides, carries or conveys the second indicator could be used to provide, carry or convey the Ncand report content(s)/quantity(s) specific to/for the candidate beam(s). The CSI field that provides, carries or conveys the first indicator in a/the UEI report, and/or the CSI field that provides, carries or conveys the second indicator in a/the UEI report, could be fixed—e.g., the CSI field that provides, carries or conveys the first (or second) indicator could correspond to the first (or 1^{st}) CSI field in a/the UEI report, and/or the CSI field that provides, carries or conveys the second (or first) indicator could correspond the first (or 1^{st}) CSI field that follows or is after the last CSI field that provides, carries or conveys the report content(s)/quantity(s) including resource indicator(s) such as SSBRI(s)/CRI(s) and/or beam metric(s) such as L1-RSRP(s)/L1-SINR(s) corresponding to the current serving (or candidate) beam(s)—in FIG. 7B, a conceptual example capturing the UEI reporting format according to those specified herein in the present disclosure is provided. Furthermore, the CSI field that provides, carries or conveys the first indicator in a/the UEI report, and/or the CSI field that provides, carries or conveys the second indicator in a/the UEI report, could be determined according to/based on (i) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (ii) UE's autonomous determination/selection, which could be further sent to the network via various UL channels/signals including PUCCH, PUSCH, PRACH, and/or etc.
In another example, for (3), each of the report contents/quantities (such as resource indicators SSBRIs/CRIs and/or beam metrics L1-RSRPs/L1-SINRs) in a UEI report could be associated/corresponding/specific to an indicator, which could be conveyed, provided, indicated, contained, included or comprised in the (same) UEI report. For example, the indicator could correspond to a set index/indicator for a serving beam(s) RS set denoted by s̅₀ according to those specified herein in the present disclosure or a candidate beam(s) RS set denoted by s̅₁ according to those specified herein in the present disclosure—e.g., the indicator (or equivalently, the set index/indicator) could be ‘0’ (or ‘1’ or ‘2’) for the serving beam(s) RS set, and ‘1’ (or ‘0’ or ‘2’) for the candidate beam(s) RS set. For another example, the indicator could correspond to a one-bit indicator with ‘0’ (or ‘1’ or ‘2’) corresponding to/indicating the serving beam(s) RS set and/or information related to current serving beam(s), and ‘1’ (or ‘0’ or ‘2’) corresponding to/indicating the candidate beam(s) RS set and/or information related to candidate beam(s). In this case, when/if an indicator associated/corresponding/specific to a report content/quantity as specified/defined herein in the present disclosure in a UEI report is set to ‘0’ (or ‘1’ or ‘2’), the report content/quantity could be associated/corresponding/specific to the current serving beam(s), and when/if an indicator associated/corresponding/specific to a report content/quantity as specified/defined herein in the present disclosure in a UEI report is set to ‘1’ (or ‘0’ or ‘2’), the report content/quantity could be associated/corresponding/specific to the candidate beam(s).
In another example, the UEI report could comprise, include, provide, contain or indicate a bitmap with each bit position or entry in the bitmap corresponding/associated to a report content/quantity (such as a resource indicator SSBRI/CRI and/or a beam metric L1-RSRP/L1-SINR) in the UEI report. In this case, when/if a bit position/entry of the bitmap is set to ‘0’ (or ‘1’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to current serving beam(s), and/or when/if a bit position/entry of the bitmap is set to ‘1’ (or ‘0’), the report content(s)/quantity(s) including resource indicator(s) such as SSBRI(s)/CRI(s) and/or beam metric(s) such as L1-RSRP(s)/L1-SINR(s) in the UEI report corresponding/associated to the bit position/entry could be for or could correspond to candidate beam(s).
In another example, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a first (RSRP/SINR) threshold. In this case, when/if a beam metric such as a L1-RSRP or a L1-SINR reported in the UEI report is below (or beyond) the first threshold, the report content(s)/quantity(s) including a resource indicator such as a SSBRI or a CRI associated/corresponding to the beam metric could be or could correspond to a serving beam. Optionally, a UE could be provided/indicated/configured by the network, e.g., via higher layer RRC signaling(s)/parameter(s) and/or MAC CE command(s) and/or dynamic DCI based L1 signaling(s)—according to or based on a UE's capability or capability signaling, a second (RSRP/SINR) threshold. In this case, when/if a beam metric such as a L1-RSRP or a L1-SINR reported in the UEI report is beyond (or below) the second threshold, the report content(s)/quantity(s) including a resource indicator such as a SSBRI or a CRI associated/corresponding to the beam metric could be or could correspond to a candidate beam.

In the design examples specified/described herein in the present disclosure, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s). For instance, the indicator(s) could be one-bit indicator(s), and when/if an indicator is set to ‘0’ (or ‘1’), the resource indicator(s) associated or corresponding or specific to the indicator in a UEI report could correspond to a SSBRI, and when/if an indicator is set to ‘1’ (or ‘0’), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s). For instance, the indicator(s) could be one-bit indicator(s), and when/if an indicator is set to ‘0’ (or ‘1’), the radio link/beam quality(s)/metric(s) associated or corresponding or specific to the indicator in a UEI report could correspond to a L1-RSRP, and when/if an indicator is set to ‘1’ (or ‘0’), the radio link/beam quality(s)/metric(s) associated or corresponding or specific to the indicator in the UEI report could correspond to a L1-SINR.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 00, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

Under the unified TCI framework described herein, a UE could receive a (unified) TCI state(s) activation/deactivation (MAC CE) command, used to map up to a number of activated TCI states and/or pairs of activated TCI states, with one activated TCI state for DL channels/signals and/or one activated TCI state for UL channels/signals to the codepoints of the DCI field ‘Transmission Configuration Indication’ for one or for a set of component carriers CCs/DL bandwidth parts (BWPs), and if applicable, for one or for a set of CCs/UL BWPs. That is, a UE could receive from the network, in/via a (unified) TCI state(s) activation/deactivation (MAC CE) command, up to a number of TCI codepoints of the DCI field ‘Transmission Configuration Indication’ for one or for a set of CCs/DL BWPs, and if applicable, for one or for a set of CCs/UL BWPs with each TCI codepoint mapped to an activated TCI state and/or a pair of activated TCI states, with one activated TCI state for DL channels/signals and/or one activated TCI state for UL channels/signals. In the present disclosure, an activated TCI state can also be referred to as an activated beam, and vice versa.

The RS(s) or RS resource(s) or RS resource index(es) of/for a current serving beam—denoted by current serving beam RS(s) or RS resource(s) or RS resource index(es)—could be identified or determined according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a tracking reference signal (TRS) is also a type of CSI-RS.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-1): a set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure.
(explicit configuration example-2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE (e.g., the UE 116) could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to one or more of:
(explicit configuration example-A): a set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network (e.g., the network 130) a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource indexe(s)—could be identified or determined according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration example-i): a set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.
(explicit configuration example-ii): a set s̅₂ of SS/PBCH block indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring L1-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Furthermore, the UE could identify or determine a subset of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D as the RS(s) or RS resource(s) or RS resource index(es) for the actual measurement for/of one or more candidate/new beams.
In one example, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.
In another example, the UE could determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams according to one or more of the followings, based on e.g. (1) fixed rule(s) in system specification(s) or per RRC (re)configuration, (ii) network's configuration(s) or indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection.
   For example, the first (or last) L≥1 candidate RS(s) or RS resource(s) or RS resource index(es) or the L≥1 candidate RS(s) or RS resource(s) with the lowest (or highest) resource index(es)—among the K configured/determined candidate RS(s) or RS resource(s) or RS resource index(es) with L≤K—could be used/applied as the RS(s) or RS resource(s) or RS resource index(es) for the actual measurement for/of the one or more candidate/new beams. Optionally, the first (or last) half of the K configured/determined candidate RS(s) or RS resource(s) or RS resource index(es) or the half of the K configured/determined candidate RS(s) or RS resource(s) with the lowest (or highest) resource index(es) could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #2 in the set s̅₁ (i.e., the first half) could be used/applied as the RS(s) or RS resource(s) for the actual measurement for/of the one or more candidate/new beams.
   For another example, the even-ordered or even-numbered or even-indexed candidate RS(s) or RS resource(s) or RS resource index(es) or the candidate RS(s) or RS resource(s) with even-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #2 and RS index #4 (even-valued RS resource indexes) in the set s̅₁ could be used/applied as the RS(s) or RS resource(s) for the actual measurement for/of the one or more candidate/new beams.
   For another example, the odd-ordered or odd-numbered or odd-indexed candidate RS(s) or RS resource(s) or RS resource index(es) or the candidate RS(s) or RS resource(s) with odd-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the explicit configuration example-A/B in the present disclosure), the RSs or RS resources corresponding/associated to the RS index #1 and RS index #3 (odd-valued RS resource indexes) in the set s̅₁ could be used/applied as the RS(s) or RS resource(s) for the actual measurement for/of the one or more candidate/new beams.
In another example, the UE (e.g., the UE 116) could indicate or transmit or send to the network, e.g., by/in part of a/the UEI beam report, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine/identify and/or indicate to the network that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine/identify and/or indicate to the network that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine/identify and/or indicate to the network that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.

As specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. In particular, the one or more indicators as defined/specified herein in the present disclosure could be provided or indicated or contained or comprised or included or configured in a/the higher layer parameter TCI-State or TCI-UL-State that configures or provides the indicated TCI state.
In one example, the one or more indicators could be or could correspond to a set of RS resource index(es)—e.g., a set of CSI-RS resource configuration index(es) and/or SSB index(es). As discussed/specified herein in the present disclosure, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the one or more indicators (or equivalently, the set of RS resource index(es)) provided, indicated, contained, comprised, configured or included in a/the higher layer parameter TCI-State or TCI-UL-State that configures or provides the indicated TCI state could provide or indicate or contain or include or comprise one or more indexes each belonging to {1, . . . , K}. Specifically, when/if the RS resource indexes in the set provided, indicated, contained, comprised, configured or included in a/the higher layer parameter TCI-State or TCI-UL-State that configures or provides the indicated TCI state correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
In another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). As discussed/specified herein in the present disclosure, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the entries/bit positions in the bitmap provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the entry(s)/bit position(s) in the bitmap provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.
In another example, the one or more indicators could be or could correspond to one or more 1-bit indicators each corresponding/associated to a candidate RS/RS resource/RS resource index or one of the candidate RS(s) or RS resource(s) or RS resource index(es). As discussed/specified herein in the present disclosure, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the explicit configuration example-A/B in the present disclosure), the 1-bit indicators provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the 1-bit indicators provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.

For the described/specified design examples herein, when/if the higher layer parameter TCI-State or TCI-UL-State that configures or provides the indicated TCI state does not provide, contain, indicate, include, comprise or configure any of the one or more indicators as specified/defined herein in the present disclosure, and/or the one or more indicators as specified/defined herein in the present disclosure is absent or not present in the higher layer parameter TCI-State or TCI-UL-State that configures or provides the indicated TCI state, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B and/or determined following those specified/described in the implicit determination example-A, the implicit determination example-B, the implicit determination example-C and/or the implicit determination example-D to obtain the actual corresponding measurement result(s) for/of the one or more candidate/new beams. As specified or discussed herein in the present disclosure, a/the UE could indicate or send or transmit to the network (e.g., the network 130), e.g., by/in part of their capability or capability signaling, whether or not they are capable of receiving/detecting/using/applying or support to receive/detect/use/apply the one or more indicators as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; for instance, a/the UE could indicate or send or transmit to the network, e.g., by/in part of their capability or capability signaling, whether or not they are capable of receiving/detecting/using/applying or support to receive/detect/use/apply the one or more indicators provided, contained, indicated, included, comprised or configured in the higher layer parameter TCI-State or TCI-UL-State that configures or provides the indicated TCI state as defined/specified herein in the present disclosure to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. Optionally, when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is greater than or equal to a first threshold/number/value, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, (ii) follow those specified in the implicit determination example-A/B/C/D, and/or (iii) follow other subset based candidate RS(s)/RS resource(s)/RS resource index(es) indication/identification/determination method(s) as discussed or specified herein in the present disclosure, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the candidate RS(s) or RS resource(s) or RS resource index(es) configured following those specified/described in the present disclosure, e.g., those specified/described in the explicit configuration example-A/B, to obtain the actual corresponding measurement result(s) for/of the one or more candidate/new beams is less than or equal to the first threshold/number/value, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the explicit configuration example-A/B to obtain the actual corresponding measurement result(s) for/of the one or more candidate/new beams. In this case, the UE could determine or identify the first threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Alternatively, when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-AB) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is less than or equal to a second threshold/value/number, the UE could expect to or could (i) receive/detect/apply/use the one or more indicators as defined/specified herein in the present disclosure, e.g., provided, contained, indicated, included, comprised or configured in the higher layer parameter TCI-State or TCI-UL-State that configures or provides the indicated TCI state, and/or (ii) follow those specified in the explicit configuration example-A/B, to determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams; otherwise, i.e., when/if a/the total number of the one or more TCI states activated by/in the TCI state(s) activation/deactivation MAC CE command (or a/the total number of the corresponding RS(s)/RS resource(s)/RS resource index(es) associated to/with the one or more TCI states as specified in the implicit determination example-A/B) and/or a/the total number of the one or more TCI states provided/configured in a higher layer RRC configured list of TCI state(s)—or a/the total number of the corresponding RS(s)/RS resource(s)/RS resource index(es) associated to/with the one or more TCI states as specified in the implicit determination example-C/D—is greater than or equal to the second threshold/value/number, the UE could assess or evaluate the radio link/beam quality(s), e.g., by measuring the L1-RSRP(s)/L1-SINR(s), of the candidate RS(s) or RS resource(s) or RS resource index(es) determined following those specified/described in the implicit determination example-A, the implicit determination example-B, the implicit determination example-C and/or the implicit determination example-D to obtain the actual corresponding measurement result(s) for/of the one or more candidate/new beams. In this case, the UE could determine or identify the second threshold/value/number according to or based on: (i) a fixed value in system specification(s) or per RRC (re)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

Furthermore, the UE could first determine or identify, e.g., based on or according to (i) fixed rule(s) in system specification(s) or per RRC (re)configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), one or more first candidate TCI states, wherein the first candidate TCI state(s) could be from a list of TCI state(s) higher layer configured or provided by the network, e.g., a list of joint/DL TCI state(s) provided by DLorJointTCI-State, and/or a set of TCI state(s) activated in/by a TCI state(s) activation/deactivation MAC CE command, and the (QCL source) RS(s) or RS resource(s) or RS resource index(es) provided in each of the first candidate TCI state(s) could correspond to a candidate candidate/new beam RS or RS resource or RS resource index as specified/defined herein in the present disclosure. Additionally, the UE could also determine or identify one or more of or a subset of the first candidate TCI state(s) as one or more second candidate TCI state(s) following or according to those specified or defined herein in the present disclosure for determining or identifying the actual candidate/new beam RS(s)/RS resource(s)/RS resource index(es) from the candidate candidate/new beam RS(s)/RS resource(s)/RS resource index(es)—including the indication(s)/configuration(s)/usage(s)/application(s) of the one or more indicators such as bitmap(s)/i-bit indicator(s)/etc. as specified/defined herein in the present disclosure, wherein the (QCL source) RS(s) or RS resource(s) or RS resource index(es) provided in each of the second candidate TCI state(s) could correspond to an actual candidate/new beam RS or RS resource or RS resource index as defined/specified herein in the present disclosure.

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc.

A UE could determine or identify an instance of a first event or Event-1 (or a given event as specified/defined herein in the present disclosure or used throughout the present disclosure) according to or based on or corresponding to:
In one example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources as specified/defined herein in the present disclosure.
   For example, the UE could determine or identify the one or more activated beams/TCI states or the one or more activation beam RSs/RS resource according to or based on fixed value(s) in system specification(s) and/or per RRC (re-)configuration. For instance, the one or more activated beams/TCI states could correspond to the activated beam/TCI state among the activated beams/TCI states in the (unified) TCI state(s) activation/deactivation MAC CE command that has the highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure. Alternatively, the one or more activated beams/TCI states could correspond to the activated beam/TCI state among the activated beams/TCI states in the (unified) TCI state(s) activation/deactivation MAC CE command that has the lowest measured beam quality/metric such as L1-RSRP(s)/L1-SINR(s)—e.g., obtained by measuring, assessing or evaluating activation beam RS(s)/RS resource(s) associated/specific to the activated beam(s)(TCI state(s) according to or following those specified herein in the present disclosure. Optionally, the one or more activated beams/TCI states could correspond to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)(TCI state(s) according to or following those specified herein in the present disclosure, wherein the value of m could be fixed in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)(TCI codepoint(s) in the MAC CE command is M). Similarly, the one or more activation beam RSs or RS resources could have the highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. Alternatively, the one or more activation beam RSs or RS resources could have the lowest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. Optionally, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the value of m could be fixed in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)(TCI codepoint(s) in the MAC CE command is M).
   For another example, the UE could determine or identify the one or more activated beams/TCI states or the one or more activation beam RSs/RS resource according to or based on network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. For instance, the one or more activated beams/TCI states could correspond to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the value of m could be configured or provided or indicated by the network e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M). Similarly, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the value of m could be configured or provided or indicated by the network e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)(TCI codepoint(s) in the MAC CE command is M).
   For another example, the UE (e.g., the UE 116) could determine or identify the one or more activated beams/TCI states or the one or more activation beam RSs/RS resource according to or based on UE's autonomous determination or selection, which could be further sent or transmitted to the network via/by various UL channels/signals e.g. in/by part of a CSI/beam report and/or a UE's capability signaling. For instance, the one or more activated beams/TCI states could correspond to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)(TCI state(s) according to or following those specified herein in the present disclosure, wherein the value of m could be according to or based on UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)(TCI codepoint(s) in the MAC CE command is M). Similarly, the one or more activation beam RSs or RS resources could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the value of m could be according to or based on UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M).
   For another example, the UE could determine or identify that the one or more activated beams/TCI states could correspond to the activated beams/TCI states in the (unified) TCI state(s) activation/deactivation MAC CE command, and the beam quality(s)/metric(s) of or corresponding to the one or more activated beams/TCI states could correspond to averaged and/or filtered L1-RSRP(s) of or corresponding to the activated beams/TCI states in the (unified) TCI state(s) activation/deactivation MAC CE command according to or based on (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Similarly, the UE could determine or identify that the one or more activation beam RSs or RS resources could correspond to the activation beam RSs or RS resources corresponding, specific or associated to the activated beams/TCI states in the (unified) TCI state(s) activation/deactivation MAC CE command, and the beam quality(s)/metric(s) of or corresponding to the one or more activation beam RSs or RS resources could correspond to averaged and/or filtered L1-RSRP(s) of or corresponding to the activation beam RSs or RS resources corresponding, specific or associated to the activated beams/TCI states in the (unified) TCI state(s) activation/deactivation MAC CE command according to or based on (i) fixed rule(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states or the one or more activation beam RSs/RS resources could be a second threshold value lower than or equal to the beam quality/metric (e.g., a measured L1-RSRP/L1-SINR) of the current serving beam or current serving beam RS/RS resource according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states could be a second threshold value greater than or equal to the lowest measured beam quality/metric such as L1-RSRP(s)/L1-SINR(s)—e.g., obtained by measuring, assessing or evaluating activation beam RS(s)/RS resource(s) associated/specific to the corresponding activated beam(s)(TCI state(s) according to or following those specified herein in the present disclosure—of the activated beam/TCI state among the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a second threshold value greater than or equal to the lowest measured beam quality/metric such as L1-RSRP(s)/L1-SINR(s) of an activation beam RS or RS resource among the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states could be a second threshold value greater (or lower) than or equal to a beam quality/metric (e.g., the averaged and/or filtered beam quality/metric) such as (averaged and/or filtered) L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a second threshold value greater (or lower) than or equal to the beam quality/metric (e.g., the averaged and/or filtered beam quality/metric) such as L1-RSRP(s)/L1-SINR(s) (e.g., averaged and/or filtered L1-RSRP(s)/L1-SINR(s)) of the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states or the one or more activation beam RSs/RS resources could be a second threshold value lower than or equal to the beam quality/metric (e.g., a measured L1-RSRP/L1-SINR) of the current serving beam or current serving beam RS/RS resource according to or following those specified herein in the present disclosure, and the beam quality(s)/metric(s)—e.g., measured L1-RSRP(s)/L1-SINR(s)—of the one or more activated beams/TCI states could be a third threshold value greater than or equal to the lowest measured beam quality/metric such as L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beam/TCI state among the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a third threshold value greater than or equal to the lowest measured beam quality/metric such as L1-RSRP(s)/L1-SINR(s) of an activation beam RS or RS resource among the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.
In another example, the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured L1-RSRP(s)/L1-SINR(s)—of one or more activated beams/TCI states or one or more activation beam RSs/RS resources according to or following those specified/defined herein in the present disclosure, and the beam quality(s)/metric(s)—e.g., measured L1-RSRP(s)/L1-SINR(s)—of the one or more activated beams/TCI states or the one or more activation beam RSs/RS resources could be a second threshold value lower than or equal to the beam quality/metric (e.g., a measured L1-RSRP/L1-SINR) of the current serving beam or current serving beam RS/RS resource according to or following those specified herein in the present disclosure, and the beam quality(s)/metric(s)—e.g., measured L1-RSRP(s)/L1-SINR(s)—of the one or more activated beams/TCI states could be a third threshold value greater (or lower) than or equal to a beam quality/metric (e.g., the averaged and/or filtered beam quality/metric) such as (averaged and/or filtered) L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beams/TCI states in the (unified) TCI state(s) activation/deactivation MAC CE command—or equivalently, the beam quality(s)/metric(s)—e.g., measured L1-RSRP(s)/L1-SINR(s)—of the one or more activation beam RSs/RS resources could be a third threshold value greater (or lower) than or equal to the beam quality/metric (e.g., the averaged and/or filtered beam quality/metric) such as L1-RSRP(s)/L1-SINR(s) (e.g., averaged and/or filtered L1-RSRP(s)/L1-SINR(s)) of the activation beam RSs or RS resources corresponding, specific or associated to the activated beams/TCI states in the (unified) TCI state(s) activation/deactivation MAC CE command according to or following those specified herein in the present disclosure. The UE could determine or identify the one or more activated beams/TCI states and/or the one or more activation beam RSs/RS resources according to or following those specified/provided herein in the present disclosure.

The UE could determine or identify the value(s) of the first threshold and/or the second threshold and/or the third threshold according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For the described design example(s) herein, the beam quality(s)/metric(s)—e.g., measured L1-RSRP(s)/L1-SINR(s)—of the determined or identified at least one (same) candidate/new beam or candidate/new beam RS/RS resource could also be:
a fourth threshold value lower than or equal to the beam quality/metric (e.g., a measured L1-RSRP/L1-SINR) of the current serving beam or current serving beam RS/RS resource according to or following those specified herein in the present disclosure, and/or
a fifth threshold value greater than or equal to the lowest measured beam quality/metric such as L1-RSRP(s)/L1-SINR(s)—e.g., obtained by measuring, assessing or evaluating activation beam RS(s)/RS resource(s) associated/specific to the corresponding activated beam(s)(TCI state(s) according to or following those specified herein in the present disclosure—of the activated beam/TCI state among the activated beams/TCI states in the (unified) TCI state(s) activation/deactivation MAC CE command—or equivalently, greater than or equal to the lowest measured beam quality/metric such as L1-RSRP(s)/L1-SINR(s) of an activation beam RS or RS resource among the activation beam RSs or RS resources corresponding, specific or associated to the activated beams/TCI states in the (unified) TCI state(s) activation/deactivation MAC CE command according to or following those specified herein in the present disclosure, and/or
a sixth threshold greater (or lower) than or equal to a beam quality/metric (e.g., the averaged and/or filtered beam quality/metric) such as (averaged and/or filtered) L1-RSRP(s)/L1-SINR(s)—e.g., obtained by measuring, assessing or evaluating activation beam RS(s)/RS resource(s) associated/specific to the corresponding activated beam(s)/TCI state(s) according to or following those specified herein in the present disclosure—of the activated beams/TCI states in the (unified) TCI state(s) activation/deactivation MAC CE command—or equivalently, greater (or lower) than or equal to the beam quality/metric (e.g., the averaged and/or filtered beam quality/metric) such as L1-RSRP(s)/L1-SINR(s) (e.g., averaged and/or filtered L1-RSRP(s)/L1-SINR(s)) of the activation beam RSs or RS resources corresponding, specific or associated to the activated beams/TCI states in the (unified) TCI state(s) activation/deactivation MAC CE command according to or following those specified herein in the present disclosure,
   wherein the UE could determine or identify the value(s) of the fourth threshold and/or the fifth threshold and/or the sixth threshold according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on corresponding UE's capability(s) or capability signaling(s), and/or (iii) UE's autonomous determination(s)/selection(s), which could be further sent to the network via various UL channels/signals and/or in part of a CSI/beam report and/or UE's capability signaling. The UE could evaluate an instance of the event (as specified/defined herein in the present disclosure) and/or detect or declare the event according to or following those specified herein in the present disclosure when/if the number of activated TCI states/pairs of TCI states or TCI codepoints in the (unified) TCI state(s) activation/deactivation MAC CE command is greater (or less) than a threshold. Here, the UE could determine or identify the threshold value according to: (i) a fixed value in system specification(s)—e.g., 4, 6 or 8, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or Event-2) according to or based on or corresponding to: the UE could determine or identify at least one (same) candidate/new beam or candidate/new beam RS/RS resource that has a beam quality/metric (e.g., a measured L1-RSRP/L1-SINR) a seventh threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the seventh threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or Event-3) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to an eighth threshold, wherein the UE could determine or identify the eighth threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

As specified/discussed herein in the present disclosure, a UE could indicate or send or transmit to the network a capability signaling indicating whether or not the UE can support one or more of the events as specified herein in the present disclosure. For instance, the corresponding capability or capability signaling could comprise one or more of the following components—i.e., if the corresponding capability or capability signaling comprises {Event-1, Event-3}, the UE could indicate or send or transmit to the network that they could support or could be capable of supporting the Event-1 and Event-3 in the present disclosure:
{Event-1}
{Event-2}
{Event-3}
{Event-1, Event-2}
{Event-1, Event-3}
{Event-2, Event-3}
{Event-1, Event-2, Event-3}

Furthermore, UEs that could or would support the UE-initiated or event-driven reporting should support or indicate their support of one or more of the events—such as Event-1; i.e., the one or more of the events—such as Event-1 in the present disclosure—could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more (e.g., only one or more than one) of the events (e.g., Event-1 and/or Event-2) can be enabled. For instance, a higher layer parameter eventType could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting, and/or in the higher layer parameter(s) LTM-Config, LTM-CSI-ResourceConfig, LTM-CSI-ReportConfig and/or etc. that provides or configures information or settings for the L1/L2 triggered mobility (LTM) operation(s). For example, when/if the eventType is set to ‘Event-1’ or ‘one’ or ‘1’ or ‘first’ or ‘enabled’ (or ‘disabled’) or 1 (or 0), the Event-1 as specified/described herein in the present disclosure is enabled; and when/if the eventType is set to ‘Event-2’ or ‘second’ or ‘2‘ or’2nd’ or ‘two’ or ‘disabled’ (or ‘enabled’) or 0 (or 1), the Event-2 as specified/described herein in the present disclosure is enabled. For another example, when/if the eventType is set to ‘Event-1 and Event-2’ or ‘one and second’ or ‘1 and 2’ or ‘first and second’ or ‘enabled’ (or ‘disabled’) or 1 (or 0) or ‘00’ (or ‘01’ or ‘10’ or ‘11’), both the Event-1 and Event-2 as specified/defined herein in the present disclosure are enabled. Throughout the present disclosure, discussions, descriptions, specifications and etc. for when one/an event (e.g., Event-1 or Event-2) is enabled (e.g., detection, declaration, triggering and etc. of the event) can be equally applied or extended to when more than one events (e.g., both Event-1 and Event-2) are enabled (e.g., detection, declaration, triggering and etc. of the more than one events). In another example, the UE may not expect the network to configure or enable any two or three of the {Event-1, Event-2, Event-3}—e.g., Event-1 and Event-2, at a same time.

A given event or an event or the event used throughout the present disclosure could correspond to or could be referred to as a/the first event as specified/defined herein in the present disclosure unless otherwise specified. Furthermore, an instance of a given event or an event or the event used throughout the present disclosure could correspond to or could be referred to as an instance of a/the first event as specified/defined herein in the present disclosure unless otherwise specified.

For the event discussed herein, and/or for a UE to declare the event, and/or for a UE to formulate, construct, transmit and/or send the UEI report(s) with the report content(s)/quantity(s) corresponding to the event according to or following those specified herein in the present disclosure, and/or for a UE to use/apply the event for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of the event, individually:
   2> if an indication for an instance for an event specified/defined according to those specified herein in the present disclosure has been received from lower layers:
      3> start or restart the EventInstanceDetectionTimer (higher layer configured for the event—when/if applicable)
      3> increment Event_COUNTER, secondEvent COUNTER, thirdEvent COUNTER or fourthEvent_COUNTER (higher layer configured respectively for the first, second, third or fourth event—when/if applicable) by 1;
      3> if Event_COUNTER>=EventInstanceMaxCount (for the event—when/if applicable), wherein the EventInstanceMaxCount is higher layer configured for the event—when/if applicable:
         4> trigger a UEI (beam) reporting specific to the event—when/if applicable—for this Serving Cell, wherein the report content(s)/quantity(s) in the UEI report(s) could be specific to the event—when/if applicable—according to or following those specified herein in the present disclosure.
   2> if the EventnstanceDetectionTimer (for the event—when/if applicable) expires; or
   2> if the EventnstanceDetectionTimer (for the event—when/if applicable), Event_COUNTER (for the event—when/if applicable), or any of the reference signals (and/or the corresponding configured, activated and/or indicated TCI state(s)) used for UEI reporting—e.g., including that/those specific to/for the current serving beam(s)/rCI state(s) and/or the candidate beam(s)/rCI state(s) and/or the activated beam(s)/rCI state(s) as specified or defined herein in the present disclosure specific to/for the event—is reconfigured by upper layers associated with this Serving Cell; or
   2> if the reference signal(s) associated with this Serving Cell used for detection/declaration/indication for the event as specified/defined herein in the present disclosure is changed and/or reconfigured by upper layers associated with this Serving Cell:
      3> set Event_COUNTER to 0; and/or
      3> stop the ueiReportingTimer, if configured; and/or
      3> regard the UE-initiated (UEI) reporting procedure triggered or initiated with respect to the event successfully completed, and/or cancel the UEI report(s) triggered or initiated with respect to the event for this Serving Cell.

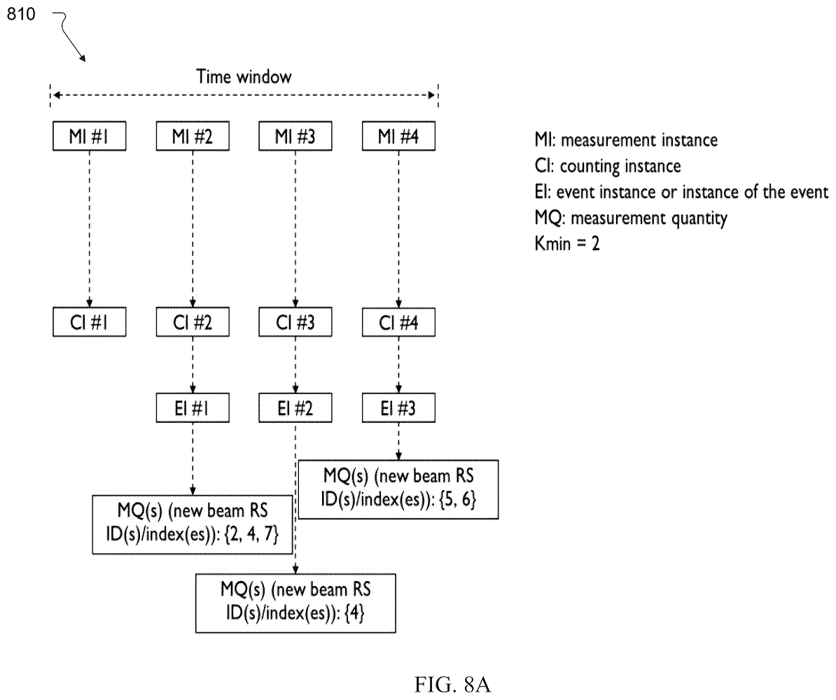

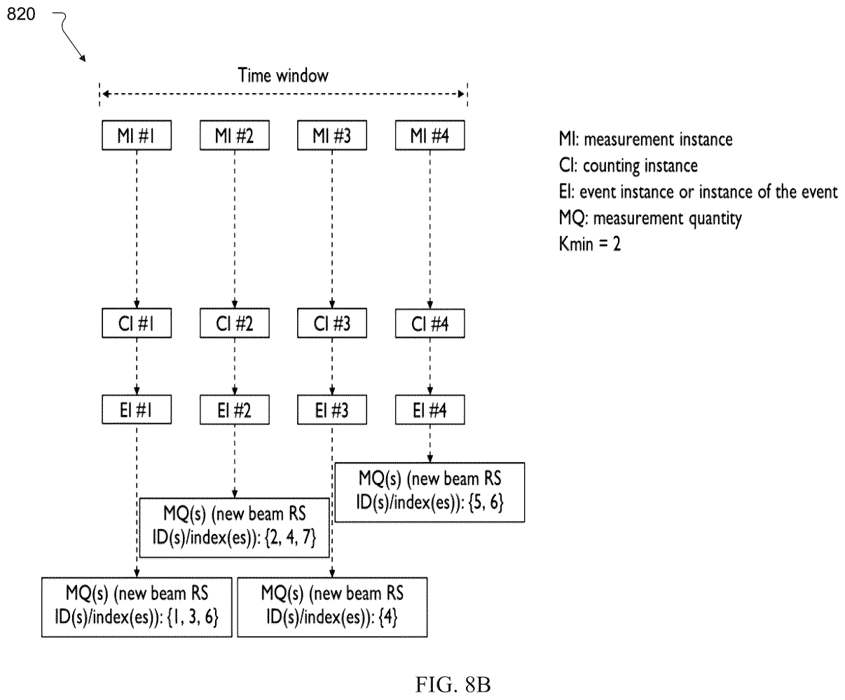

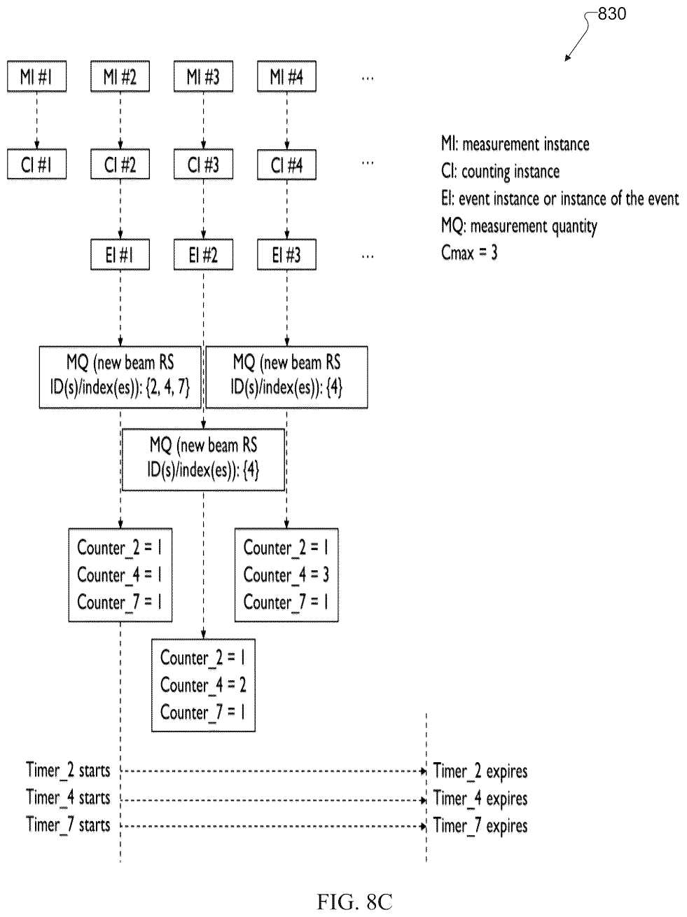

FIGS. 8A, 8B, and 8C illustrate examples of event evaluation procedure(s) for UEI beam reporting 810, 820, and 830, respectively, according to embodiments of the present disclosure. For example, examples of event evaluation procedure(s) 810, 820, and 830, respectively, can be followed by any of the UEs 111-116 of FIG. 1, such as the UE 116. This example is for illustration only and other embodiments can be used without departing from the scope of the present disclosure.

With reference to FIG. 8A, both EI #1 and EI #2 (number of counts=2) have a common MQ (i.e., new beam RS ID/index 4)) within the time window. In this case, the number of counts (2) is equal to Kmin (2). Hence, the event can be declared and the corresponding UEI beam reporting can be initiated/triggered with the new beam RS ID/index 4 as a candidate report quantity/content.

With reference to FIG. 8B, both EI #1 and EI #4 (number of counts=2) have a common MQ (i.e., new beam RS ID/index 6) within the time window. In this case, the number of counts (2) is equal to Kmin (2), and both EI #2 and EI #3 (number of counts=2) have a common MQ (i.e., new beam RS ID/index 4). In this case, the number of counts (2) is equal to Kmin (2). Hence, the event can be declared and the corresponding UEI beam reporting can be initiated/triggered with the new beam RS IDs/indexes 4 and 6 as candidate report quantity(s)/content(s).

With reference to FIG. 8C, the number of counts in Counter_4 specific/associated to new beam RS ID/index 4 (a MQ) reaches to the maximum number of counts Cmax=3 before the corresponding Timer_4 expires. Hence, the UE can declare the event, initiate/trigger a beam reporting with the new beam RS ID/index 4 as a candidate report quantity/content, reset Counter_2/Counter_4/Counter_7 to zero(s), and reset Timer_2/Timer_4/Timer_7.

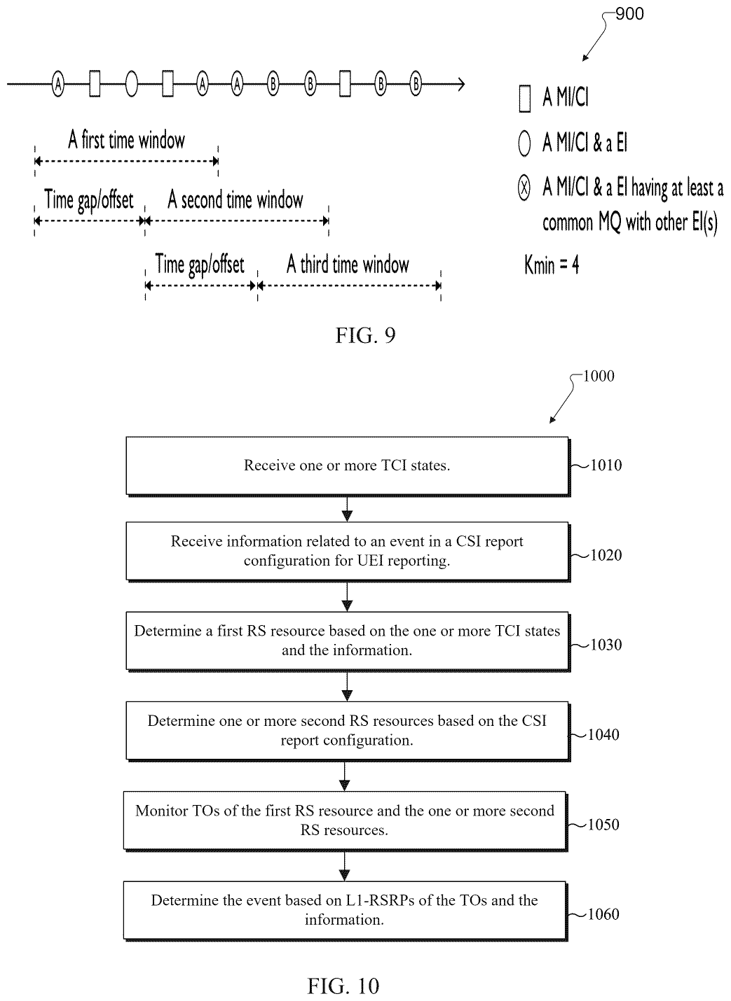

FIG. 9 illustrates an example of determining time window(s) for event evaluation 900 for UEI beam reporting according to embodiments of the present disclosure. For example, determining time window(s) for event evaluation 900 can be followed by the UE 116 of FIG. 2. This example is for illustration only and other embodiments can be used without departing from the scope of the present disclosure.

As specified herein in the present disclosure, to declare an event and to trigger the corresponding (beam) reporting, a UE (e.g., the UE 116) would need to first determine or identify, for a given counting instance, whether or not an instance of the event is detected. When/if a UE has detected an instance for an event (and therefore for a counting instance corresponding/associated to the detection of the instance of the event)—i.e., the UE has detected or determined or identified that the condition(s) for the event has been satisfied or achieved—the UE (e.g., higher layer(s) of the UE) could increase the number of count(s)—e.g., in the event counter specific or associated to the event as specified/defined herein in the present disclosure—for declaring the event by 1. Here, a counting instance could also correspond or could be associated to a measurement instance such that for a given event and a counting instance, a UE could obtain, determine or identify one or more measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs. To trigger a (beam) report based on declaration/detection of an event, the UE (or the higher layer(s) of the UE) could determine or identify whether a/the maximum or a/the minimum number of counts—e.g., in the event counter specific or associated to the event as specified/defined herein in the present disclosure—has been achieved before a corresponding event instance detection timer expires following or according to those specified herein in the present disclosure based on or according to or following one or more of:
In one example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1. Furthermore, when/if the UE has identified, determined or detected a second (or current) instance of the event, the UE (e.g., the higher layer(s) of the UE) could increase the number of count(s), e.g., in the event counter specific/associated to the event, by 1. In this design example, a first counting instance (or a corresponding/associated measurement instance as specified/defined herein in the present disclosure) and a second counting instance (or a corresponding/associated measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the UE could determine or identify first/second measurement quantity(s) as specified/defined herein in the present disclosure corresponding/associated to a first/second counting/measurement instance corresponding/associated to the detection of the first (or previous)/second (or current) instance of the event; furthermore, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the first counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if (e.g., each of) the second measurement quantity(s) is identical to or the same as (e.g., each of) the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the fast counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE (e.g., higher layer(s) of the UE) could increase the number of count(s), e.g., in the event counter specific/associated to the event, by 1; furthermore, the UE could determine or identify first measurement quantity(s) as specified/defined herein in the present disclosure corresponding/associated to a first counting/measurement instance corresponding/associated to the detection of the first (or previous) instance of the event. Furthermore, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and when/if at least one of the second measurement quantity(s) is identical to or the same as at least one of the first measurement quantity(s), the UE (e.g., the higher layer(s) of the UE) could increase the number of count(s), e.g., in the event counter specific/associated to the event, by 1. In this design example, the first counting instance (or the corresponding/associated first measurement instance as specified/defined herein in the present disclosure) and the second counting instance (or the corresponding/associated second measurement instance as specified/defined herein in the present disclosure) respectively associated/corresponding to the first (or previous) and second (or current) instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s) and the second measurement quantity(s) as defined/specified herein in the present disclosure respectively associated/specific to the first (or previous) and second (or current) instances of the event as described/specified herein in the present disclosure could be regarded as first and second candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance and the measurement instance—denoted by a second measurement instance—corresponding/associated to the second counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between the measurement instance—denoted by a first measurement instance—corresponding/associated to the fast counting instance and the measurement instance—denoted by a second measurement instance—corresponding/associated to the second counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first and second measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if (e.g., each of) the second measurement quantity(s), . . . , (e.g., each of) the K-th measurement quantity(s) is identical to or the same as (e.g., each of) the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if at least one of the second measurement quantity(s), . . . , at least one of the K-th measurement quantity(s) is identical to or the same as at least one of the first measurement quantity(s), the UE could declare the event and trigger or initiate the corresponding (beam) reporting. In this design example, value of K could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if a/the number of instances of the event—denoted by K_1≥1 out of the total number of instances of the event, i.e., K_1≤K—that have at least one same measurement quantity (denoted by first same measurement quantity(s)) is less than (or greater than) or equal to a threshold (denoted by Kmax) or greater than (or less than) or equal to a threshold (denoted by Kmin), and/or a/the number of instances of the event—denoted by K_2≥1 out of the total number of instances of the event, i.e., K_2≤K—that have at least one same measurement quantity (denoted by second same measurement quantity(s)) is less than (or greater than) or equal to a threshold (denoted by Kmax) or greater than (or less than) or equal to a threshold (denoted by Kmin), and so on, and/or a/the number of instances of the event—denoted by K_k≥1 out of the total number of instances of the event. i.e., K_k≤K—that have at least one same measurement quantity (denoted by k-th same measurement quantity(s)) is less than (or greater than) or equal to a threshold (denoted by Kmax) or greater than (or less than) or equal to a threshold (denoted by Kmin), wherein k∈{1, 2, . . . , Btot} with Btot representing the maximum/total number of unique measurement quantities obtained/identified/determined from the K event instances, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE (e.g., the UE 116) could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . , the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. Two conceptual examples are presented in FIG. 8A and FIG. 8B. In FIG. 8A, the UE could determine or identify three instances of the event (denoted by event instance (EI) #1, EI #2 and EI #3) from four measurement instances (MIs)/counting instances (CIs) in the time window/period/gap/offset, and in FIG. 8B, the UE could determine or identify four instances of the event (denoted by EI #1, EI #2, EI #3 and EI #4) from four MIs/CIs within the time window/period/gap/offset. Among the three determined/identified EIs in FIG. 3, the two (equal to Kmin=2 in this design example) EI #1 and EI #2 have a/the same measurement quantity—i.e., a new beam RS ID/index 4; hence, according to those specified herein in the present disclosure, the UE could declare the event and initiate/trigger a beam reporting with the new beam RS ID/index 4 as a candidate report quantity/content. Among the four determined/identified EIs in FIG. 4, the two (equal to Kmin=2 in this design example) EI #1 and EI #4 have a/the same measurement quantity—i.e., a new beam RS ID/index 6, and the two (equal to Kmin=2 in this design example) EI #2 and EI #3 have a/the same measurement quantity—i.e., a new beam RS ID/index 4; hence, according to those specified herein in the present disclosure, the UE could declare the event and initiate/trigger a beam reporting with the new beam RS IDs/indexes 4 and 6 as candidate report quantities/contents.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. When/if there is at least one common/same measurement quantity (e.g., in terms of new beam RS ID(s)/index(es)) among the first, second, . . . , and/or K-th measurement quantities as specified/defined herein in the present disclosure and/or the number of at least one of the common/same measurement quantities—denoted by/referred to as triggering measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or K-th measurement quantities as specified/defined herein in the present disclosure, and/or when/if a/the number of one or more same/common measurement quantities—denoted by/referred to as first same measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or K-th measurement quantities as specified/defined herein in the present disclosure is less than (or greater than) or equal to a threshold (denoted by Kmax) or greater than (or less than) or equal to a threshold (denoted by Kmin), k∈{1, 2, . . . , Btot} with Btot representing the maximum/total number of unique measurement quantities obtained/identified/determined from the K event instances, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as specified/defined herein in the present disclosure, and/or the first same measurement quantity(s), the second same measurement quantity(s), . . . , the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine an event instance counter specific/associated to the k-th instance of the event wherein k=1, . . . , K. The UE (e.g., higher layer(s) of the UE) could increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the l-th instance of the event wherein l∈{1, . . . , K} and l≠k, that has at least one same measurement quantity, denoted by k′-th same measurement quantity(s) wherein k′∈{1, . . . , Btot} with Btot representing the maximum/total number of unique measurement quantities obtained/identified/determined from the K event instances, as that determined or identified for the k-th instance of the event. When/if a/the number of count(s) in at least one event instance counter as specified/defined herein in the present disclosure reaches to the maximum number of count(s)—denoted by Cmax, wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in each of the event instance counter(s) as specified/defined herein in the present disclosure to zero(s) when/if (1) the number of count(s) in the corresponding event instance counter has reached to Cmax, and/or (2) after, e.g., the last symbol/slot/etc. of, the K-th measurement instance or the K-th counting instance or the K-th instance of the event or out of the time window/period/gap/offset as specified/defined herein in the present disclosure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), . . . , the k′-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine an event instance counter specific/associated to the k-th instance of the event wherein k=1, . . . , K, . . . . The UE (e.g., higher layer(s) of the UE) could start a timer specific/associated to the k-th instance of the event and/or increase the number of count(s), e.g., in the event instance counter specific/associated to the k-th event instance, by 1, when/if (1) the UE has identified, determined or detected the k-th instance of the event, and/or (2) the UE has identified, determined or detected another event instance, denoted by the l-th instance of the event wherein l∈{1, . . . , K, . . . } and l≠k, that has at least one same measurement quantity, denoted by k′-th same measurement quantity(s) wherein k′∈{1, . . . , Btot} with Btot representing the maximum/total number of unique measurement quantities obtained/identified/determined from the event instances, as that determined or identified for the k-th instance of the event. When/if a/the number of count(s) in at least one event instance counter as specified/defined herein in the present disclosure reaches to the maximum number of count(s)—denoted by Cmax—before the corresponding timer expires (the corresponding same measurement quantity(s) specific/associated to the at least one event instance counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the event instance counter specific/associated to the k-th instance of the event as specified/defined herein in the present disclosure to zero and/or reset the timer specific/associated to the k-th instance of the event when/if (1) the number of count(s) in the event instance counter specific/associated to the k-th instance of the event has reached to Cmax, and/or (2) the timer specific/associated to the k-th instance of the event has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For a m-th measurement quantity, wherein m=1, 2, . . . , Btot with Btot representing the total/maximum number of unique measurement quantities obtained/identified/determined from the K event instances, the UE could determine or identify a/the number of event instance(s)—denoted by K_m≥1 out of the total number of instances of the event, i.e., K_m≤K—that have at least the m-th measurement quantity. In this case, when/if at least one of K_1, . . . , K_Btot is less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, when/if K_k (k∈{1, . . . , Btot}) is less than (or greater than) or equal to a threshold (denoted by Kmax) or greater than (or less than) or equal to a threshold (denoted by Kmin), the k-th measurement quantity as defined/specified herein in the present disclosure could be regarded as one of candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event. For this design example, the UE could determine a measurement quantity counter specific/associated to a m-th measurement quantity, wherein m=1, . . . , Btot with Btot representing the total/maximum number of unique measurement quantities obtained/identified/determined from the K event instances. The UE (e.g., higher layer(s) of the UE) could increase the number of count(s), e.g., in the measurement quantity counter specific/associated to the m-th measurement quantity, by 1, when/if the UE has identified, determined or detected a/the same value of the m-th measurement quantity from any of the K event instances and therefore their corresponding/associated counting/measurement instances. When/if a/the number of count(s) in at least one measurement quantity counter as specified/defined herein in the present disclosure reaches to the maximum number of count(s)—denoted by Cmax (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero when/if (1) the number of count(s) in the measurement quantity counter specific/associated to the m-th measurement quantity has reached to Cmax, and/or (2) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. For this design example, the UE could determine a measurement quantity counter specific/associated to a m-th measurement quantity, wherein m=1, 2, . . . , Btot, . . . with Btot representing the total/maximum number of unique measurement quantities obtained/identified/determined from the K event instances. The UE (e.g., higher layer(s) of the UE) could start a timer specific/associated to the m-th measurement quantity and/or increase the number of count(s), e.g., in the measurement quantity counter specific/associated to the m-th measurement quantity, by 1, when/if the UE has identified, determined or detected a/the same value of the m-th measurement quantity from any of the (K) event instances and therefore their corresponding/associated counting/measurement instances. When/if a/the number of count(s) in at least one measurement quantity counter as specified/defined herein in the present disclosure reaches to the maximum number of count(s)—denoted by Cmax—before the corresponding timer expires (the corresponding measurement quantity(s) specific/associated to the at least one measurement quantity counter is denoted by triggering measurement quantity(s)), wherein the value(s) of Cmax could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, the UE could declare the event and trigger or initiate the corresponding (beam) reporting—in this case, measurement quantity(s) is associated to a corresponding instance of the event as specified/defined herein in the present disclosure. Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The UE could reset the number(s) of count(s) in the measurement quantity counter specific/associated to the m-th measurement quantity as specified/defined herein in the present disclosure to zero and/or reset the timer specific/associated to the m-th measurement quantity when/if (1) the number of count(s) in the measurement quantity counter specific/associated to the m-th measurement quantity has reached to Cmax, and/or (2) the timer specific/associated to the m-th measurement quantity has expired and/or (3) the UE has initiated, triggered or started the UE-initiated beam reporting process/procedure. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. Optionally, the triggering measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. One conceptual example characterizing the described/specified design procedures herein is provided in FIG. 8C. As can be seen from FIG. 8C, only the number of counts in the measurement quantity counter specific/associated to the measurement quantity of new beam RS ID/index 4 (denoted by Counter_4 in FIG. 8C) has reached to the maximum number of counts Cmax before the corresponding timer specific/associated to the measurement quantity of new beam RS ID/index 4 (denoted by Timer_4 in FIG. 8C) expires. In this case, the UE could declare the event and initiate/trigger a beam reporting with at least the new beam RS ID/index 4 as a candidate report quantity/content.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, wherein the first instance of the event (or the corresponding/associated first counting/measurement instance as specified/defined herein in the present disclosure), the second instance of the event (or the corresponding/associated second counting/measurement instance as specified/defined herein in the present disclosure), . . . , and the K-th instance of the event (or the corresponding/associated K-th measurement/counting instance as specified/defined herein in the present disclosure) could be within a t-th (e.g., t∈{1, . . . , T}) time window/period/gap/offset (e.g., in terms of number of symbols/slots/etc.), wherein the value(s) of T and/or the t-th time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if at least one of the second measurement quantity(s), . . . , at least one of the K-th measurement quantity(s) is identical to or the same as at least one of the first measurement quantity(s)—denoted by/as channel triggering condition(s)—within the t-th time window/period/gap/offset as specified/defined herein in the present disclosure, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE (e.g., the UE 116) could declare the event and trigger or initiate the corresponding (beam) reporting. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s), and K could be less than (or greater than) or equal to a threshold (denoted by Kmax) or greater than (or less than) or equal to a threshold (denoted by Kmin), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event—within the t-th time window/period/gap/offset—as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event—denoted by K_1≥1 out of the total number of instances of the event within the t-th time window/period/gap/offset, i.e., K_1≤Kt—that have at least one same measurement quantity (denoted by first same measurement quantity(s)) is less than (or greater than) or equal to a threshold (denoted by Kmax) or greater than (or less than) or equal to a threshold (denoted by Kmin)—denoted by/referred to as channel triggering condition(s), and/or a/the number of instances of the event—denoted by K_2≥1 out of the total number of instances of the event within the t-th time window/period/gap/offset, i.e., K_2≤Kt—that have at least one same measurement quantity (denoted by second same measurement quantity(s)) is less than (or greater than) or equal to a threshold (denoted by Kmax) or greater than (or less than) or equal to a threshold (denoted by Kmin)—denoted by/referred to as channel triggering condition(s), and so on, and/or a/the number of instances of the event—denoted by K_k≥1 out of the total number of instances of the event within the t-th time window/period/gap/offset, i.e., K_k≤Kt—that have at least one same measurement quantity (denoted by k-th same measurement quantity(s)) is less than (or greater than) or equal to a threshold (denoted by Kmax) or greater than (or less than) or equal to a threshold (denoted by Kmin)—denoted by/referred to as channel triggering condition(s), wherein k∈{1, 2, . . . , Btot,t} with Btot,t representing the maximum/total number of unique measurement quantities obtained/identified/determined from the Kt event instances within the t-th time window/period/gap/offset, and the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . , the k-th same measurement quantity(s) as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if a/the number of instances of the event that have at least one same measurement quantity (denoted by triggering measurement quantity(s)) within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring (or counting) the instance(s) of the event (and therefore, the corresponding measurement/counting instance(s)) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received. A conceptual example characterizing the described design procedure(s) herein is presented in FIG. 9. As illustrated in FIG. 9, only within the third time window/period/gap/offset, the number of counts of the instances of the event that have at least one common measurement quantity (e.g., in term of new beam RS ID(s)/index(es)) is equal to Kmin (i.e., 4 in this example). Hence, the UE could declare the event and trigger/initiate a beam reporting after the third time window/period/offset/gap. Note there that there is a time gap/offset t_p between two adjacent time windows/periods/offsets/gaps in time, which can be configured/provided by the network, e.g., via higher layer RRC signaling/parameter (e.g., provided in higher layer parameter(s) such as CSI-ResourceConfig, CSI-ReportConfig, UEI-ReportConfig or UEI-ResourceConfig that provides necessary information/settings for the UEI beam reporting).
In another example, as specified herein in the present disclosure, for a given event, when/if a UE (e.g., the UE 116) has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure and/or the number of at least one of the common/same measurement quantities—denoted by/referred to as triggering measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by or referred to as channel trigging condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the t-th time window/period/gap/offset ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. That is, when/if there is at least one common/same measurement quantity (e.g., in terms of new beam RS ID(s)/index(es)) among the first, second, . . . , and/or Kt-th measurement quantities within the t-th time window/period/gap/offset as specified/defined herein in the present disclosure, and/or when/if a/the number of one or more same/common measurement quantities—denoted by/referred to as first same measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and/or when/if a/the number of one or more same/common measurement quantities—denoted by/referred to as second same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin), and so on, and/or when/if a/the number of one or more same/common measurement quantities—denoted by/referred to as k-th same/common measurement quantity(s)—among the first, second, . . . , and/or Kt-th measurement quantities within the t-th time window/period/gap/offset as specified/defined herein in the present disclosure is less than (or greater than) or equal to a threshold (denoted by Kmax) or greater than (or less than) or equal to a threshold (denoted by Kmin)—denoted by/referred to as channel triggering condition(s), k∈{1, 2, . . . , Btot} with Btot representing the maximum/total number of unique measurement quantities obtained/identified/determined from the Kt event instances within the t-th time window/period/gap/offset, and/or when/if the t-th time window/period/gap/offset ends the earliest in time than the other time window(s)/period(s)/gap(s)/offset(s) each having one or more same/common measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of same/common measurement quantity(s) in the (t+1)-th, (t+2)-th, . . . , T-th time window/period/gap/offset and so on and/or after the last symbol/slot/etc. of the t-th time window/period/gap/offset until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the t-th time window/period/gap/offset and other time window(s)/period(s)/gap(s)/offset(s) than the t-th time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Optionally, the first same measurement quantity(s), the second same measurement quantity(s), . . . , the k-th same measurement quantity(s)—within the t-th time window/period/gap/offset—as defined/specified herein in the present disclosure could be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.
In another example, as specified herein in the present disclosure, for a given event, when/if a UE has identified, determined or detected a first (or previous) instance of the event, the UE could determine or identify first measurement quantity(s) as specified/defined herein in the present disclosure corresponding/associated to a first counting/measurement instance corresponding/associated to the detection of the first (or previous) instance of the event, when/if the UE has identified, determined or detected a second (or current) instance of the event, the UE could determine or identify second measurement quantity(s) as specified/defined herein in the present disclosure corresponding/associated to a second counting/measurement instance corresponding/associated to the detection of the second (or current) instance of the event, and so on, and/or when/if the UE has identified, determined or detected a K-th instance of the event, the UE could determine or identify K-th measurement quantity(s) as specified/defined herein in the present disclosure corresponding/associated to a K-th counting/measurement instance corresponding/associated to the detection of the K-th instance of the event, and so on. In this case, the UE could determine or identify or monitor or detect, within a first time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., within a second time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a t-th (e.g., t∈{1, . . . , T}) time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, within a T-th time window/period/gap/offset (e.g., in terms of number of slots/symbols/etc.), one or more of the instances of the event (e.g., the first, second, . . . , K-th instances of the event) and therefore the corresponding/associated measurement quantity(s), counting/measurement instance(s) and etc., and so on, wherein the value(s) of T and/or the first, second, . . . , t-th, . . . , T-th (and so on) time windows/periods/gaps/offsets could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. For this design example, the (T) time windows/periods/gaps/offsets could have a/the same value(s)/length(s), and they could be periodic with a periodicity of t_p (e.g., in terms of number of symbols/slots/etc.); optionally, the t-th and (t+1)-th time windows/periods/gaps/offsets could (or may not) overlap in time with a time gap t_p (e.g., in terms of number of symbols/slots/etc.) separating them in time—e.g., the first (or last) symbol/slot/etc. of the (t+1)-th time window/period/gap/offset could be t_p symbols/slots/etc. later in time than the first (or last) symbol/slot/etc. of the t-th time window/period/gap/offset, wherein the value(s) of t_p could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, when/if there is at least one common/same measurement quantity (e.g., in terms of new beam RS ID(s)/index(es)) among (all) the measurement quantities within at least one time window/period/offset/gap (e.g., the t-th time window/period/offset/gap), and/or when/if a/the number of at least one of the common/same measurement quantities (denoted by triggering measurement quantity(s)) among (all) the measurement quantities within at least one time window/period/offset/gap (e.g., the t-th time window/period/offset/gap) is less than (or greater than) or equal to a threshold (denoted by Kmax) or greater than (or less than) or equal to a threshold (denoted by Kmin)—denoted by/referred to as channel triggering condition(s), wherein the threshold value(s) or value(s) of Kmax/Kmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and/or when/if the at least one (e.g., the t-th) time window/period/gap/offset as specified/defined herein in the present disclosure ends the earliest in time than the other time window(s)/period(s)/gap(s)/offset(s) each having one or more triggering measurement quantities that satisfy the channel triggering condition(s) as specified/defined herein in the present disclosure, the UE could declare the event and trigger or initiate the corresponding (beam) reporting—in this case, measurement quantity(s) is associated to a corresponding instance of the event as specified/defined herein in the present disclosure. In this design example, the UE could stop monitoring the instance(s) of the event (and therefore, the corresponding measurement/counting instance(s)) and/or counting the number(s) of common/same measurement quantity(s) in the time window(s)/period(s)/gap(s)/offset(s), e.g., the (t+1)-th, (t+2)-th, . . . , T-th time window/period/gap/offset and so on other than the at least one time window/period/gap/offset (e.g., the t-th time window/period/gap/offset) as specified/defined herein in the present disclosure and/or after the last symbol/slot/etc. of the at least one (e.g., the t-th) time window/period/gap/offset as specified/defined herein in the present disclosure until the UE has finished the UE-initiated beam reporting process/procedure—e.g., upon detection/reception of network's response(s) to the UE-initiated beam report(s). Furthermore, the first counting instance (or the corresponding/associated first measurement instance as specified/defined herein in the present disclosure), the second counting instance (or the corresponding/associated second measurement instance as specified/defined herein in the present disclosure), . . . , and the K-th counting instance (or the corresponding/associated K-th measurement instance as specified/defined herein in the present disclosure) respectively associated/corresponding to the first (or previous), second (or current) and K-th instances of the event could be consecutive in time, and/or within a time window/period/gap/offset (e.g., in terms of number of symbols/slots/etc.), wherein the value(s) of the time window/period/gap/offset could be determined according to: (i) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For this design example, the first measurement quantity(s), the second measurement quantity(s), . . . , the K-th measurement quantity(s) as defined/specified herein in the present disclosure respectively associated/specific to the first (or previous), the second (or current), . . . , and the K-th instances of the event as described/specified herein in the present disclosure could be regarded as first, second, . . . , and K-th candidate report content(s)/quantity(s)—to be or that can be sent or transmitted or reported in a UEI (beam) report as the corresponding report content(s)/quantity(s) as specified/defined herein in the present disclosure—for the event. In addition, the UE would also identify or determine one or more triggering measurement quantities that satisfy the channel triggering condition(s) as specified/defined herein in the present disclosure within overlapping time window(s)/period(s)/gap(s)/offset(s) between the at least one time window/period/gap/offset as specified/defined herein in the present disclosure, e.g., the t-th time window/period/gap/offset and other time window(s)/period(s)/gap(s)/offset(s) than the at least one (e.g., the t-th) time window/period/gap/offset; in this case, the one or more identified or determined triggering measurement quantities as defined/specified herein in the present disclosure could also be regarded as candidate report content(s)/quantity(s)—to be or that can be sent or transmitted or reported in a UEI (beam) report as the corresponding report content(s)/quantity(s) as specified/defined herein in the present disclosure—for the event. Furthermore, in this design example, the periodicity of the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the periodicity of the measurement RS(s) including SSB(s) and/or CSI-RS(s) for the current serving beam as specified herein in the present disclosure or the same as the periodicity of the measurement RS(s) including SSB(s) and/or CSI-RS(s) for the candidate/new beam(s) as specified herein in the present disclosure. Alternatively, the time gap/offset between any two consecutive (in time) measurement instances among the measurement instance—denoted by a first measurement instance—corresponding/associated to the first counting instance, the measurement instance—denoted by a second measurement instance—corresponding/associated to the second counting instance, . . . , and the measurement instance—denoted by a K-th measurement instance—corresponding/associated to the K-th counting instance could be the same as the time gap/offset between two consecutive (in time) measurement RS(s) including SSB(s) and/or CSI-RS(s) or two consecutive (in time) measurement occasions for the current serving beam as specified herein in the present disclosure or the same as the time gap/offset between two consecutive (in time) measurement RS(s) including SSB(s) and/or CSI-RS(s) or two consecutive (in time) measurement occasions for the candidate/new beam(s) as specified herein in the present disclosure. As specified herein in the present disclosure, each of the first, second, . . . , and K-th measurement instances could be corresponding to or overlaps in time with a measurement occasion, wherein in a measurement occasion, measurement RS(s) including SSB(s) and/or CSI-RS(s) for the current serving beam and/or measurement RS(s) including SSB(s) and/or CSI-RS(s) for the candidate/new beam(s) as defined/specified herein in the present disclosure could be transmitted/received.

For the design examples discussed/specified herein in the present disclosure, when/if a UE is configured/provided by the network, e.g., via higher layer RRC signaling/parameter, a parameter, the parameter could be provided in higher layer parameter(s) such as CSI-ResourceConfig, CSI-ReportConfig, UEI-ReportConfig or UEI-ResourceConfig that provides necessary information/settings for the UEI beam reporting. Furthermore, as specified herein in the present disclosure, for a measurement instance (or a counting instance), the UE could measure or assess one or more measurement RSs (for the current serving beam and/or one or more candidate/new beams as specified/defined herein in the present disclosure), obtain/determine/identify the corresponding measurement quantities including, e.g., one or more candidate/new beams (or candidate/new beam RSs or resource indicators such as SSBRIs/CRIs corresponding to the obtained/determined/identified candidate/new beam RSs) as specified/defined herein in the present disclosure and/or the corresponding beam metrics including L1-RSRPs/L1-SINRs, and determine or identify an event instance (if any). In the present disclosure, the UE (e.g., the UE 116) could identify or determine an instance of an event if the condition(s) of the event is achieved/satisfied.

As specified herein in the present disclosure, for a given event, a measurement quantity (and therefore, a corresponding candidate report content/quantity as defined/specified herein in the present disclosure) could correspond to a report content/quantity as specified herein in the present disclosure for the event. For instance, for the event as specified herein in the present disclosure, a measurement quantity and/or a triggering measurement quantity as specified/defined herein in the present disclosure (and therefore, a corresponding candidate report content/quantity as defined/specified herein in the present disclosure) could correspond to an identified candidate/new beam that satisfies the event condition, an identified candidate/new beam RS/RS resource/RS resource index (or the corresponding SSBRI/CRI) that satisfies the event condition, the current serving beam or the current serving beam RS/RS resource/RS resource index (or the corresponding SSBRI/CRI) that satisfies the event condition, an identified activation beam RS/RS resource/RS resource index (or the corresponding SSBRI/CRI) that satisfies the event condition, index/ID of a TCI codepoint—e.g., among the activated TCI codepoints in a (unified) TCI state(s) activation/deactivation MAC CE command—comprising/mapped to a TCI state associated/specific to the identified activation beam RS/RS resource/RS resource index that satisfies the event condition, index/ID of a TCI state—e.g., among the activated TCI states in a (unified) TCI state(s) activation/deactivation MAC CE command—associated/specific to the identified activation beam RS/RS resource/RS resource index that satisfies the event condition, a (measured/differential) L1-RSRP/L1-SINR value associated/specific to an identified candidate/new beam or candidate/new beam RS/RS resource/RS resource index (or the corresponding SSBRI/CRI) that satisfies the event condition, a (measured/differential) L1-RSRP/L1-SINR value associated/specific to the current serving beam or the current serving beam RS/RS resource/RS resource index (or the corresponding SSBRI/CRI) that satisfies the event condition, and a (measured/differential) L1-RSRP/L1-SINR value associated/specific to an identified activated beam/TCI state or activation beam RS/RS resource/RS resource index (or the corresponding SSBRI/CRI) that satisfies the event condition. Or, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more report contents/quantities as specified herein in the present disclosure for the event. For instance, for the Event as specified herein in the present disclosure, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more identified candidate/new beams that satisfy the Event condition, one or more identified candidate/new beam RSs/RS resources/RS resource indexes (or the corresponding SSBRIs/CRIs) that satisfy the Event condition, the current serving beam or the current serving beam RS/RS resource/RS resource index (or the corresponding SSBRI/CRI) that satisfies the Event condition, one or more identified activation beam RSs/RS resources/RS resource indexes (or the corresponding SSBRIs/CRIs) that satisfy the event condition, indexes/IDs of one or more TCI codepoints—e.g., among the activated TCI codepoints in a (unified) TCI state(s) activation/deactivation MAC CE command—comprising/mapped to one or more TCI states associated/specific to the identified one or more activation beam RSs/RS resources/RS resource indexes that satisfy the event condition, indexes/IDs of one or more TCI states—e.g., among the activated TCI states in a (unified) TCI state(s) activation/deactivation MAC CE command—associated/specific to the identified one or more activation beam RSs/RS resources/RS resource indexes that satisfy the event condition, one or more (measured/differential) L1-RSRP/L1-SINR values associated/specific to the one or more identified candidate/new beams or candidate/new beam RSs/RS resources/RS resource indexes (or the corresponding SSBRIs/CRIs) that satisfy the event condition, one or more (measured/differential) L1-RSRP/L1-SINR values associated/specific to the one or more identified activated beams/TCI states or activation beam RSs/RS resources/RS resource indexes (or the corresponding SSBRIs/CRIs) that satisfy the event condition, and a (measured/differential) L1-RSRP/L1-SINR value associated/specific to the current serving beam or the current serving beam RS/RS resource/RS resource index (or the corresponding SSBRI/CRI) that satisfies the event condition. Across different measurement instances as described/specified herein in the present disclosure, the type of the measurement RS(s) for the candidate/new beam(s) could be the same/identical, e.g., CSI-RS(s) or SSB(s). Furthermore, when/if an/the event-driven or event-triggered (beam) reporting for L1/L2 triggered mobility (LTM) is configured or enabled (e.g., when/if the UE is provided a higher layer RRC signaling/parameter LTM-Config/LTM-CSI-ResourceConfig/LTM-CSI-ReportConfig and/or ‘event-driven reporting’ in LTM-Config/LTM-CSI-ResourceConfig/LTM-CSI-ReportConfig set to ‘enabled’), for a LTM event, a measurement quantity and/or a triggering measurement quantity as specified/defined herein in the present disclosure (and therefore, a corresponding candidate report content/quantity as defined/specified herein in the present disclosure) could correspond to an identified candidate/new beam—associated to a PCI other than the serving cell PCI or the serving cell PCI—that satisfies the LTM event condition, an identified candidate/new beam RS/RS resource/RS resource index (or the corresponding SSBRI/CRI)—associated to a PCI other than the serving cell PCI or the serving cell PCI—that satisfies the LTM event condition, the current serving beam or the current serving beam RS/RS resource/RS resource index (or the corresponding SSBRI/CRI)—associated to the serving cell PCI—that satisfies the LTM event condition, a (measured/differential) L1-RSRP/L1-SINR value associated/specific to an identified candidate/new beam or candidate/new beam RS/RS resource/RS resource index (or the corresponding SSBRI/CRI)—associated to a PCI other than the serving cell PCI or the serving cell PCI—that satisfies the LTM event condition, and a (measured/differential) L1-RSRP/L1-SINR value associated/specific to the current serving beam or the current serving beam RS/RS resource/RS resource index (or the corresponding SSBRI/CRI)—associated to the serving cell PCI—that satisfies the LTM event condition. In addition, for the LTM event, the first, second, . . . , and/or K-th measurement quantity(s) as defined/specified herein in the present disclosure (and therefore, the corresponding first, second, . . . , and/or K-th candidate report content(s)/quantity(s) as defined/specified herein in the present disclosure) and/or the triggering measurement quantity(s) as specified/defined herein in the present disclosure could correspond to or comprise one or more of: one or more identified candidate/new beams—associated to one or more PCIs other than the serving cell PCI or the serving cell PCI (and/or associated to one or more candidate cells other than the serving cell or the serving cell)—that satisfy the LTM event condition, one or more identified candidate/new beam RSs/RS resources/RS resource indexes (or the corresponding SSBRIs/CRIs)—associated to one or more PCIs other than the serving cell PCI or the serving cell PCI (or associated to one or more candidate cells other than the serving cell or the serving cell)—that satisfy the LTM event condition, the current serving beam or the current serving beam RS/RS resource/RS resource index (or the corresponding SSBRI/CRI)—associated to the serving cell PCI—that satisfies the LTM event condition, one or more (measured/differential) L1-RSRP/L1-SINR values associated/specific to the one or more identified candidate/new beams or candidate/new beam RSs/RS resources/RS resource indexes (or the corresponding SSBRIs/CRIs)—associated to one or more PCIs other than the serving cell PCI or the serving cell PCI (or associated to one or more candidate cells other than the serving cell or the serving cell)—that satisfy the LTM event condition, and a (measured/differential) L1-RSRP/L1-SINR value associated/specific to the current serving beam or the current serving beam RS/RS resource/RS resource index (or the corresponding SSBRI/CRI)—associated to the serving cell PCI—that satisfies the LTM event condition. Across different measurement instances as described/specified herein in the present disclosure, the type of the measurement RS(s) for the candidate/new beam(s) could be the same/identical, e.g., CSI-RS(s) or SSB(s), and/or the measurement RS(s) for the candidate/new beam(s) could be associated to a/the same PCI (e.g., a PCI other than the serving cell PCI or the serving cell PCI)—or a/the same candidate cell (e.g., a candidate cell other than the serving cell or the serving cell)—or different PCIs (e.g., different PCIs other than the serving cell PCI or different PCIs comprising one or more PCIs other than the serving cell PCI and the serving cell PCI)—or different candidate cells (e.g., different candidate cells other than the serving cell or different candidate cells comprising one or more candidate cells other than the serving cell and the serving cell). Here, a PCI could correspond to an exact PCI value or a PCI index pointing/corresponding to an entry (e.g., an exact PCI value) of a list of (exact) PCI value(s) higher layer provided/configured to the UE, e.g., for the LTM operation(s), and/or a candidate cell could correspond to an exact PCI value or an index pointing/corresponding to an entry (e.g., an exact PCI value) of a list of candidate cell(s)/candidate cell index(es) higher layer provided/configured to the UE, e.g., for the LTM operation(s).

After the UE has declared an event, the UE could trigger or initiate a (beam) reporting following those specified/described herein in the present disclosure, and transmit or send to the network a UEI (beam) report comprising at least one or more report contents/quantities (including resource indicator(s) such as SSBRI(s)/CRI(s) and the corresponding beam metric(s) such as L1-RSRP(s)/L1-SINR(s)) that satisfy/achieve the event condition(s), which could be determined according to one or more of:
In one example, the one or more report contents/quantities in the UEI (beam) report could comprise or could be determined/identified/selected from the candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   The first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from one or more of the first candidate report content(s)/quantity(s), one or more of the second candidate report content(s)/quantity(s), . . . , and one or more of the K-th candidate report content(s)/quantity(s) that are the same as/identical to each other as defined/specified herein in the present disclosure, wherein the first, second and K-th candidate report content(s)/quantity(s) are obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same components of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from one or more (e.g., M≥1) of the first candidate report content(s)/quantity(s), one or more (e.g., M≥1) of the second candidate report content(s)/quantity(s), . . . , and one or more (e.g., M≥1) of the K-th candidate report content(s)/quantity(s) that are the same as/identical to each other as defined/specified herein in the present disclosure, wherein the first, second and K-th candidate report content(s)/quantity(s) are obtained, identified or determined by the UE during the process of event declaration or declaring an event according to or following those specified herein in the present disclosure, and M could be greater than (or less than) or equal to a threshold value (denoted by Mmin). Here, the threshold value or value of Mmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same (e.g., the common, identical or same M≥1) components of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure, and M could be greater than (or less than) or equal to a threshold value (denoted by Mmin). Here, the threshold value or value of Mmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same components of one or more of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from common, identical or same components of one or more (e.g., Q≥1) of the first candidate report content(s)/quantity(s), the second candidate report content(s)/quantity(s), . . . , and the K-th candidate report content(s)/quantity(s) as defined/specified herein in the present disclosure obtained, identified or determined by the UE during the process of event declaration or declaring an event according to or following those specified herein in the present disclosure, and Q could be greater than (or less than) or equal to a threshold value (denoted by Qmin). Here, the threshold value or value of Qmin could be determined according to: (i) a fixed or predetermined value (e.g., 2) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could only comprise or could only be determined/identified/selected from one or more of the first candidate report content(s)/quantity(s) obtained, identified or determined by the UE at the very beginning during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could only comprise or could only be determined/identified/selected from one or more of the K-th candidate report content(s)/quantity(s) obtained, identified or determined by the UE at the very last/end during the process of event declaration or declaring an event according to or following those specified herein in the present disclosure. In this case, one or more of the following conditions could be achieved/satisfied (first):
   The first, second, . . . , and K-th candidate report content(s)/quantity(s) as defined/specified herein in the present disclosure could be the same as/identical to each other
   At least one of the first candidate report content(s)/quantity(s), at least one of the second candidate report content(s)/quantity(s), . . . , and at least one of the K-th candidate report content(s)/quantity(s) as defined/specified herein in the present disclosure could be the same as/identical to each other
   One or more of the first, second, . . . , and K-th candidate report content(s)/quantity(s) as defined/specified herein in the present disclosure could be different from each other
   One or more report contents/quantities of one or more of the first, second, . . . , and K-th candidate report content(s)/quantity(s) as defined/specified herein in the present disclosure could be the same as/identical to each other
In another example, the one or more report contents/quantities in the UEI (beam) report could comprise or could be determined/identified/selected from one or more of the first same measurement quantity(s), the second same measurement quantity(s), . . . , and the k-th/k′-th same measurement quantity(s) as defined/specified herein in the present disclosure obtained, identified or determined by the UE during the process of event declaration or declaring an event according to or following those specified herein in the present disclosure (e.g., according to or following those described/specified one or more examples), wherein k and/or k′∈{1, 2, . . . , Btot} with Btot representing the maximum/total number of unique measurement quantities obtained/identified/determined from the relevant (e.g., K) event instances. In this case, one or more of the following conditions could be achieved/satisfied (first):
   The first, second, . . . , and k-th/k′-th same measurement quantities as defined/specified herein in the present disclosure could be the same as/identical to each other
   At least one of the first same measurement quantity(s), at least one of the second same measurement quantity(s), . . . , and at least one of the k-th/k′-th same measurement quantity(s) as defined/specified herein in the present disclosure could be the same as/identical to each other
   One or more of the first, second, . . . , and k-th/k′-th same measurement quantities as defined/specified herein in the present disclosure could be different from each other
   One or more report contents/quantities corresponding to one or more of the first, second, . . . , and k-th/k′-th same measurement quantities as defined/specified herein in the present disclosure could be the same as/identical to each other
In another example, the one or more report contents/quantities in the UEI (beam) report could comprise or could be determined/identified/selected from one or more of the triggering measurement quantities as defined/specified herein in the present disclosure obtained, identified or determined by the UE during the process of event declaration or declaring an event according to or following those specified herein in the present disclosure (e.g., according to or following those described/specified in one or more examples herein), wherein the triggering measurement quantity(s) could or should satisfy or achieve the channel triggering condition(s) as specified/defined herein in the present disclosure. In this case, one or more of the following conditions could be achieved/satisfied (first):
   The triggering measurement quantities as defined/specified herein in the present disclosure could be the same as/identical to each other
   One or more of the triggering measurement quantities as defined/specified herein in the present disclosure could be the same as/identical to each other or different from each other
   One or more report contents/quantities corresponding to one or more of the triggering measurement quantities as defined/specified herein in the present disclosure could be the same as/identical to each other

A UE (e.g., the UE 116) could indicate or send or transmit to the network a capability signaling indicating whether or not the UE can or would like to support one or more of the described/specified processes and/or procedures herein of declaring an event or event declaration (including the event counter—e.g., with a candidate value of maximum number of counts as zero, event instance detection timer—e.g., with a candidate value of zero, those described/specified in one or more examples herein). Furthermore, UEs that could or would support the UE-initiated or event-driven reporting should or could support or indicate their support of a candidate value of zero of the maximum number of counts for the event counter(s) and/or a candidate value of 0 of the event instance detection timer(s); i.e., supporting of a candidate value of zero of the maximum number of counts for the event counter and/or a candidate value of 0 of the event instance detection timer(s) could be specified or regarded as basic UE feature(s). The UE could be indicated, provided or configured by the network, e.g., via higher layer RRC signaling(s)/parameter(s) and/or MAC CE command(s) and/or dynamic DCI based L1 signaling(s) based on a corresponding UE's capability or capability signaling as discussed herein, that one or more of the described/specified processes or procedures herein of declaring an event or event declaration (including the event counter, event instance detection timer, those described/specified in one or more examples herein) could be enabled. For instance, a higher layer parameter eventDeclaration could be configured or provided or indicated in the higher layer parameter(s) CSI-ReportConfig, CSI-ResourceConfig, and/or UE-ReportConfig, UEI-ResourceConfig, etc. that provides or configures information or settings for the UE-initiated or event-driven beam reporting. For instance, when/if the eventDeclaration is present/configured/provided and/or set to ‘on’ or ‘enabled’ or 1, the event counter(s), the event instance detection timer(s), etc. and the corresponding MAC procedures as specified/described herein could be enabled for the UE for declaring the event(s). Otherwise, i.e., when/if the eventDeclaration is set to ‘off’ or ‘disabled’ or 0 or absent or not present/configured/provided, the event counter(s), the event instance detection timer(s), etc. and the corresponding MAC procedures as specified/described herein could be disabled or not used/applied by the UE for declaring the event(s).

According to or following those specified herein in the present disclosure, a UE could determine or identify one or more candidate/new beam RSs or RS resources to measure, assess or evaluate (e.g., to obtain the corresponding measurement result(s) including L1-RSRP(s)/L1-SINR(s)), e.g., for evaluating instance(s) of an event or evaluating or declaring an event according to or following those specified herein in the present disclosure, according to or based on one or more of:
In one example, the one or more candidate/new beam RS resources could be provided or configured in a CSI resource set in a CSI resource setting associated/linked to a CSI reporting setting, wherein the CSI resource set, the CSI resource setting and/or the CSI reporting setting could be provided or configured for the UE-initiated/event-driven beam reporting as specified/defined herein in the present disclosure.
   For example, the one or more candidate/new beam RS resources—corresponding to SSBs—could be provided or configured in a SSB resource set configured for reporting ‘ssb-Index-RSRP’/‘ssb-Index-RSRP’ and provided by CSI-SSB-ResourceSet in the CSI resource setting associated/linked to the CSI reporting setting.
   For another example, the one or more candidate/new beam RS resources—corresponding to nonzero power (NZP) CSI-RS resources—could be provided or configured in a NZP CSI-RS resource set configured for reporting ‘cri-RSRP’/‘cri-RSRP’ and provided by NZP-CSI-RS-ResourceSet in the CSI resource setting associated/linked to the CSI reporting setting.
In another example, the one or more candidate/new beam RS resources could be associated to a joint/DL/UL TCI state configured, activated or indicated for at least UE-dedicated transmission(s) and/or reception(s) of various DL and/or UL channels/signals. For instance, information related to the one or more candidate/new beam RS resources could be provided or configured in a higher layer parameter TCI-State or UL-TCIState that provides or configures a joint/DL/UL TCI state, wherein the one or more candidate/new beam RS resources could be associated/linked/specific to a CSI reporting setting or configuration, e.g., provided by CSI-ReportConfig, configured for CSI/beam and/or UEI CSI/beam measurement and/or reporting. For this design example, the information could correspond to or comprise or include or contain or provide one or more of:
   Index(es)/ID(s) of the one or more candidate/new beam RS resources, wherein bitwidth of the index(es)/ID(s) of the one or more candidate/new beam RS resources could be [log₂L], where L here is the number of RS resources in a list/set/pool of RS resources (higher layer) configured/provided to the UE for candidate/new beam RS(s) measurement and/or reporting.
   Index(es)/ID(s) of the one or more candidate/new beam RS resources, wherein bitwidth of the index(es)/ID(s) of the one or more candidate/new beam RS resources could be [log₂M], where M here is the number of RS resources in a CSI resource set in a CSI resource setting associated/linked to a CSI reporting setting, wherein the CSI resource set, the CSI resource setting and/or the CSI reporting setting could be provided or configured for the UE-initiated/event-driven beam reporting as specified/defined herein in the present disclosure.
   Index(es)/ID(s) of one or more CSI resource sets—e.g., among the CSI resource sets provided/configured in a CSI resource setting associated/linked to a CSI reporting setting, wherein the CSI resource set(s), the CSI resource setting and/or the CSI reporting setting could be provided or configured for the UE-initiated/event-driven beam reporting as specified/defined herein in the present disclosure; in this case, the one or more candidate/new beam RS resources could correspond to the RS resource(s) in the one or more CSI resource sets.

Optionally, a higher layer parameter TCI-State or UL-TCIState that provides or configures a joint/DL/UL TCI state could comprise, provide, contain, include or configure first information related to one or more SSBs as first candidate/new beam RS resource(s), wherein the first candidate/new beam RS resource(s)—i.e., the one or more SSBs—could be associated/linked/specific to a CSI reporting setting or configuration, e.g., provided by CSI-ReportConfig, configured for CSI/beam and/or UEI CSI/beam measurement and/or reporting, and second information related to one or more NZP CSI-RS resources as second candidate/new beam RS resource(s), wherein the second candidate/new beam RS resource(s)—i.e., the one or more NZP CSI-RS resources—could be associated/linked/specific to a CSI reporting setting or configuration, e.g., provided by CSI-ReportConfig, configured for CSI/beam and/or UEI CSI/beam measurement and/or reporting. In this case, the first information could correspond to or comprise or include or contain or provide one or more of:
Index(es)/ID(s) of the SSBs (i.e., index(es)/ID(s) of the one or more first candidate/new beam RS resources), wherein bitwidth of the index(es)/ID(s) of the SSBs could be [log₂L₁], where L₁ here is the number of SSBs in a list/set/pool of SSBs (higher layer) configured/provided to the UE for candidate/new beam RS(s) measurement and/or reporting.
Index(es)/ID(s) of the SSBs (i.e., index(es)/ID(s) of the one or more first candidate/new beam RS resources), wherein bitwidth of the index(es)/ID(s) of the SSBs could be [log₂L₂], where L₂ here is the number of SSBs in a SSB resource set—e.g., provided by CSI-SSB-ResourceSet—in a CSI resource setting associated/linked to a CSI reporting setting, wherein the SSB resource set, the CSI resource setting and/or the CSI reporting setting could be provided or configured for the UE-initiated/event-driven beam reporting as specified/defined herein in the present disclosure.
Index(es)/ID(s) of one or more SSB resource sets—e.g., among the SSB resource sets provided/configured in a CSI resource setting associated/linked to a CSI reporting setting, wherein the SSB resource set(s), the CSI resource setting and/or the CSI reporting setting could be provided or configured for the UE-initiated/event-driven beam reporting as specified/defined herein in the present disclosure; in this case, the one or more SSBs (and therefore, the one or more first candidate/new beam RS resources) could correspond to the SSB(s) in the one or more SSB resource sets.

The second information could correspond to or comprise or include or contain or provide one or more of:
Index(es)/ID(s) of the NZP CSI-RS resources (i.e., index(es)/ID(s) of the one or more second candidate/new beam RS resources), wherein bitwidth of the index(es)/ID(s) of the NZP CSI-RS resources could be [log₂L₂], where L₂ here is the number of NZP CSI-RS resources in a list/set/pool of NZP CSI-RS resources (higher layer) configured/provided to the UE for candidate/new beam RS(s) measurement and/or reporting.
Index(es)/ID(s) of the NZP CSI-RS resources (i.e., index(es)/ID(s) of the one or more second candidate/new beam RS resources), wherein bitwidth of the index(es)/ID(s) of the NZP CSI-RS resources could be [log₂L₂], where L₂ here is the number of NZP CSI-RS resources in a NZP CSI-RS resource set—e.g., provided by NZP-CSI-RS-ResourceSet—in a CSI resource setting associated/linked to a CSI reporting setting, wherein the NZP CSI-RS resource set, the CSI resource setting and/or the CSI reporting setting could be provided or configured for the UE-initiated/event-driven beam reporting as specified/defined herein in the present disclosure.
Index(es)/ID(s) of one or more NZP CSI-RS resource sets—e.g., among the NZP CSI-RS resource sets provided/configured in a CSI resource setting associated/linked to a CSI reporting setting, wherein the NZP CSI-RS resource set(s), the CSI resource setting and/or the CSI reporting setting could be provided or configured for the UE-initiated/event-driven beam reporting as specified/defined herein in the present disclosure; in this case, the one or more NZP CSI-RS resources (and therefore, the one or more second candidate/new beam RS resources) could correspond to the NZP CSI-RS resource(s) in the one or more NZP CSI-RS resource sets.

In this case, to evaluate an instance of an event or to evaluate or declare or detect an event (e.g., the event could be the second event or Event-2 as defined/specified herein in the present disclosure), when/if the UE has determined or identified (e.g., based on network's configuration(s)/indication(s) via/by higher layer RRC signaling(s)/parameter(s) and/or MAC CE command(s) and/or dynamic DCI based L1 signaling(s) based on or according to a corresponding UE's capability signaling) that the current (serving) beam RS or RS resource corresponds to a SSB associated/specific to the indicated TCI state according to or following those specified herein in the present disclosure, the UE could determine or identify that candidate beam RS(s) or RS resource(s) could correspond to the first candidate/new beam RS(s)/RS resource(s)—i.e., SSBs—provided or configured by/via the first information provided, configured or comprised in the higher layer parameter TCI-State or UL-TCIState that provides or configures the indicated TCI state. Additionally, when/if the UE has determined or identified (e.g., based on network's configuration(s)/indication(s) via/by higher layer RRC signaling(s)/parameter(s) and/or MAC CE command(s) and/or dynamic DCI based L1 signaling(s) based on or according to a corresponding UE's capability signaling) that the current (serving) beam RS or RS resource corresponds to a NZP CSI-RS resource associated/specific to the indicated TCI state according to or following those specified herein in the present disclosure, the UE could determine or identify that candidate beam RS(s) or RS resource(s) could correspond to the second candidate/new beam RS(s)/RS resource(s)—i.e., NZP CSI-RS resources—provided or configured by/via the second information provided, configured or comprised in the higher layer parameter TCI-State or UL-TCIState that provides or configures the indicated TCI state.

According to those specified herein in the present disclosure, when/if a UE is indicated by the network, e.g., via a beam activation and/or indication MAC CE or DCI (e.g., via a TCI codepoint of a TCI field in the corresponding beam indication DCI format(s) 1_1/1_2 with or without DL assignment), one or more TCI states, and/or when/if the higher layer parameter(s) TCI-State(s) and/or UL-TCIState(s) that provides or configures the one or more TCI states does not comprise, configure, provide, contain or include any information related to candidate/new beam RS(s)/RS resource(s) following or according to those specified herein in the present disclosure, and/or when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s) for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure.

According to those specified herein in the present disclosure, when/if a UE is indicated or provided by the network a (unified) TCI state(s) activation/deactivation MAC CE command comprising or indicating or providing or activating one or more TCI states or TCI codepoints each mapped to one or more TCI states, and/or when/if the number of (activated) TCI state(s)/TCI codepoint(s) in the (unified) TCI state(s) activation/deactivation MAC CE command is greater (or lower) than or equal to a threshold (the UE could determine or identify the threshold value according to or based on: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s)), and/or when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s) for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure.

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated by the network, e.g., via a beam activation and/or indication MAC CE or DCI (e.g., via a TCI codepoint of a TCI field in the corresponding beam indication DCI format(s) 1_1/1_2 with or without DL assignment), one or more TCI states, and/or when/if the higher layer parameter(s) TCI-State(s) and/or UL-TCIState(s) that provides or configures the one or more TCI states comprises, configures, provides, contains or includes information related to second candidate/new beam RS(s)/RS resource(s) following or according to those specified herein in the present disclosure, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated by the network, e.g., via a beam activation and/or indication MAC CE or DCI (e.g., via a TCI codepoint of a TCI field in the corresponding beam indication DCI format(s) 1_1/1_2 with or without DL assignment), one or more TCI states, and/or when/if the higher layer parameter(s) TCI-State(s) and/or UL-TCIState(s) that provides or configures the one or more TCI states comprises, configures, provides, contains or includes information related to second candidate/new beam RS(s)/RS resource(s) following or according to those specified herein in the present disclosure, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure, when/if one or more of the following conditions are satisfied/achieved:
In one example, the UE could be provided or configured or indicated by the network, e.g., in/by higher layer parameter(s)/signaling(s) that provides necessary information and/or configurations and/or setting(s) for the UE-initiated/event-driven beam reporting, an indicator to enable the UE to use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.
   For example, the indicator could correspond to a higher layer parameter provided by ‘enable2ndCandidateBeamRS’; in this case, when/if ‘enable2ndCandidateBeamRS’ is provided/configured and/or set to ‘enabled’ or ‘on’, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if ‘enable2ndCandidateBeamRS’ is not provided/configured/present or is absent or is provided/configured/present but set to ‘disabled’ or ‘off’, the UE could (only) use/apply the first candidate/new beam RS(s)/RS resource(s) to evaluate/declare instance(s) of the event and/or evaluate, detect or declare the event according to or following those specified herein in the present disclosure.
   For another example, the indicator could correspond to a one-bit flag indicator; in this case, when/if the one-bit flag indicator is provided/configured and/or set to ‘1’ (or ‘0’), the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the one-bit flag indicator is not provided/configured/present or is absent or is provided/configured/present but set to ‘0’ (or ‘1’), the UE could (only) use/apply the first candidate/new beam RS(s)/RS resource(s) to evaluate/declare instance(s) of the event and/or evaluate, detect or declare the event according to or following those specified herein in the present disclosure.

In this design example, the higher layer parameter(s)/signaling(s) TCI-State and/or UL-TCIState that configures or provides the indicated TCI state according to or following those specified herein in the present disclosure could provide or configure or comprise the indicator.
In another example, when/if the number of the first candidate/new beam RS resource(s) in the CSI resource set is greater (or lower) than or equal to a threshold, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the number of the first candidate/new beam RS resource(s) in the CSI resource set is lower (or greater) than or equal to the threshold, the UE could (only) use/apply the first candidate/new beam RS(s)/RS resource(s) to evaluate/declare instance(s) of the event and/or evaluate, detect or declare the event according to or following those specified herein in the present disclosure. The threshold value defined herein could be determined or identified based on or according to: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE (e.g., the UE 116) is indicated or provided by the network a (unified) TCI state(s) activation/deactivation MAC CE command comprising or indicating or providing or activating one or more TCI states or TCI codepoints each mapped to one or more TCI states, the UE could first identify or determine one or more second candidate/beam RSs or RS resources according to one or more of:
The second candidate/new beam RS(s) or RS resource(s) could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to the reference signal(s) in one or more (or all) of the (activated) TCI-State(s) or UL-TCIState(s) activated or indicated or provided by/in the (unified) TCI state(s) activation/deactivation MAC CE command. In this case, the current serving beam RS(s) or RS resource(s) could correspond to NZP CSI-RS(s) or NZP CSI-RS resource(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is NZP CSI-RS(s).

The second candidate/new beam RS(s) or RS resource(s) could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to one or more (or all) of the SSB(s) that could be QCL'ed with the reference signal(s) in one or more (or all) of the (activated) TCI-State(s) or UL-TCIState(s) activated or indicated or provided by/in a/the (unified) TCI state(s) activation/deactivation MAC CE command. In this case, the current serving beam RS(s) or RS resource(s) could correspond to SSB(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is SSB(s). The UE could then use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.

According to those specified herein in the present disclosure, when/if the UE-initiated/event-driven beam reporting is enabled or configured according to or following those specified herein in the present disclosure, and/or when/if the UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, an event (e.g., the second event or Event-2) for the UE-initiated/event-driven beam reporting, the UE could determine or identify the RS resource(s) provided/configured in a CSI resource set configured/provided for candidate/new beam RS(s) measurement and/or reporting in a CSI resource setting associated/specific to a CSI reporting setting as the candidate/new beam RS resource(s)—denoted by first candidate/new beam RS resource(s)—for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. In this case, when/if a UE is indicated or provided by the network a (unified) TCI state(s) activation/deactivation MAC CE command comprising or indicating or providing or activating one or more TCI states or TCI codepoints each mapped to one or more TCI states, the UE could first identify or determine one or more second candidate/beam RSs or RS resources according to one or more of:
The second candidate/new beam RS(s) or RS resource(s) could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to the reference signal(s) in one or more (or all) of the (activated) TCI-State(s) or UL-TCIState(s) activated or indicated or provided by/in the (unified) TCI state(s) activation/deactivation MAC CE command. In this case, the current serving beam RS(s) or RS resource(s) could correspond to NZP CSI-RS(s) or NZP CSI-RS resource(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is NZP CSI-RS(s).

The second candidate/new beam RS(s) or RS resource(s) could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in the (unified) TCI state(s) activation/deactivation MAC CE command. Or equivalently, the second candidate/new beam RS(s) or RS resource(s) could correspond to one or more (or all) of the SSB(s) that could be QCL'ed with the reference signal(s) in one or more (or all) of the (activated) TCI-State(s) or UL-TCIState(s) activated or indicated or provided by/in a/the (unified) TCI state(s) activation/deactivation MAC CE command. In this case, the current serving beam RS(s) or RS resource(s) could correspond to SSB(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is SSB(s). The UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure, when/if one or more of the following conditions are satisfied/achieved:
In one example, the UE could be provided or configured or indicated by the network, e.g., in/by higher layer parameter(s)/signaling(s) that provides necessary information and/or configurations and/or setting(s) for the UE-initiated/event-driven beam reporting, an indicator to enable the UE to use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure.
   For example, the indicator could correspond to a higher layer parameter provided by ‘enable2ndCandidateBeamRS’; in this case, when/if ‘enable2ndCandidateBeamRS’ is provided/configured and/or set to ‘enabled’ or ‘on’, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if ‘enable2ndCandidateBeamRS’ is not provided/configured/present or is absent or is provided/configured/present but set to ‘disabled’ or ‘off’, the UE could (only) use/apply the first candidate/new beam RS(s)/RS resource(s) to evaluate/declare instance(s) of the event and/or evaluate, detect or declare the event according to or following those specified herein in the present disclosure.
   For another example, the indicator could correspond to a one-bit flag indicator; in this case, when/if the one-bit flag indicator is provided/configured and/or set to ‘1’ (or ‘0’), the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the one-bit flag indicator is not provided/configured/present or is absent or is provided/configured/present but set to ‘0’ (or ‘1’), the UE could (only) use/apply the first candidate/new beam RS(s)/RS resource(s) to evaluate/declare instance(s) of the event and/or evaluate, detect or declare the event according to or following those specified herein in the present disclosure.
      In this design example, the (unified) TCI state(s) activation/deactivation MAC CE command could indicate or provide or configure or comprise the indicator (e.g., via a new field or by (repurposing) an existing, e.g., an ‘R’, field).
In another example, when/if the number of the first candidate/new beam RS resource(s) in the CSI resource set is greater (or lower) than or equal to a threshold, the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the number of the first candidate/new beam RS resource(s) in the CSI resource set is lower (or greater) than or equal to the threshold, the UE could (only) use/apply the first candidate/new beam RS(s)/RS resource(s) to evaluate/declare instance(s) of the event and/or evaluate, detect or declare the event according to or following those specified herein in the present disclosure. The threshold value defined herein could be determined or identified based on or according to: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
In another example, when/if the number of (activated) TCI state(s)/TCI codepoint(s) in the (unified) TCI state(s) activation/deactivation MAC CE command is lower (or greater) than or equal to a threshold (the UE could determine or identify the threshold value according to or based on: (i) a fixed value in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s)), the UE could use/apply the second candidate/new beam RS(s)/RS resource(s)—i.e., to replace the first candidate/new beam RS(s)/RS resource(s) and/or switch from the first candidate/new beam RS(s)/RS resource(s)—to evaluate/declare instance(s) of the event and/or evaluate, detect or declare the event according to or following those specified herein in the present disclosure; otherwise, i.e., when/if the number of (activated) TCI state(s)/TCI codepoint(s) in the (unified) TCI state(s) activation/deactivation MAC CE command is greater (or lower) than or equal to the threshold, the UE could (only) use/apply the first candidate/new beam RS(s)/RS resource(s) to evaluate/declare instance(s) of the event and/or evaluate, detect or declare the event according to or following those specified herein in the present disclosure.

The second candidate/new beam RS(s) or RS resource(s) specified/defined herein in the present disclosure could also be associated, specific or linked to a/the CSI reporting setting provided or configured for the UE-initiated/event-driven beam reporting as specified/defined herein in the present disclosure.

According to those specified herein in the present disclosure, a UE could transmit or send to the network a first capability signaling to indicate whether or not they could support using/applying RS resource(s) provided or configured in a CSI resource set in a CSI resource setting associated/linked to a CSI reporting setting to evaluate/declare instance(s) of the event and/or evaluate, detect or declare the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure. Additionally, a UE could transmit or send to the network a second capability signaling to indicate whether or not they could support using/applying candidate/new beam RS(s)/RS resource(s) provided or configured or comprised or included or contained in/by the higher layer parameter(s) TCI-State(s) and/or UL-TCIState(s) that provides or configures one or more indicated TCI states following or according to those specified herein in the present disclosure to evaluate/declare instance(s) of the event and/or evaluate, detect or declare the event according to or following those specified herein in the present disclosure. Here, the first capability signaling could be different or separate from the second capability signaling, or optionally, the first capability signaling could be identical to or same as the second capability signaling. Furthermore, a UE's basic feature (i.e., the feature that the UE has to support) could comprise one or more of:
Support of using/applying RS resource(s) provided or configured in a CSI resource set in a CSI resource setting associated/linked to a CSI reporting setting to evaluate/declare instance(s) of the event and/or evaluate, detect or declare the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure
Support of using/applying candidate/new beam RS(s)/RS resource(s) provided or configured or comprised or included or contained in/by the higher layer parameter(s) TCI-State(s) and/or UL-TCIState(s) that provides or configures one or more indicated TCI states following or according to those specified herein in the present disclosure to evaluate/declare instance(s) of the event and/or evaluate, detect or declare the event according to or following those specified herein in the present disclosure

When a UE is indicated by the network (e.g., the network 130), e.g., via a beam activation and/or indication MAC CE or DCI (e.g., via a TCI codepoint of a TCI field in the corresponding beam indication DCI format(s) 1_1/1_2 with or without DL assignment), one or more TCI states, the UE could expect that the higher layer parameter(s) TCI-State(s) and/or UL-TCIState(s) that provides or configures the one or more TCI states could comprise, configure, provide, contain or include information related to candidate/new beam RS(s)/RS resource(s) following or according to those specified herein in the present disclosure, and/or the UE could expect to use/apply the candidate/new beam RS(s)/RS resource(s) to evaluate/declare instance(s) of the event and/or evaluate, detect or declare the event according to or following those specified herein in the present disclosure if one or more of the following conditions are satisfied or achieved or held:
The UE is configured, provided or enabled by the network, e.g., via higher layer RRC signaling(s)/parameter(s) that provides (or associates/links/corresponds to) necessary CSI/beam resource and/or reporting setting(s) and/or configuration(s) for the UE-initiated/event-driven beam reporting, a specific or particular event (e.g., the second event or Event-2) for the UE-initiated/event-driven beam reporting
The UE has indicated or sent to the network, e.g., in/via a capability signaling, their support of at least an event counter and/or an event timer/time window as specified/defined herein in the present disclosure
The UE has indicated or sent to the network, e.g., in/via a capability signaling, their support of the maximum number of event instance(s), e.g., that can be higher layer configured/provided in a CSI/beam resource setting or a CSI/beam resource set for the UE-initiated/event-driven beam reporting associated/linked/specific to a CSI/beam reporting setting or configuration e.g. higher layer configured/provided for the UE-initiated/event-driven beam reporting, that the UE could use/apply, e.g., in an event counter, for evaluating or declaring the event (e.g., the second event or Event-2 or the third event or Event-3 as specified/defined herein in the present disclosure), being greater than (or less than or equal to) a threshold, wherein the threshold value could be determined or identified based on or according to: (i) fixed value(s), e.g., greater than 1, in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
The UE has indicated or sent to the network, e.g., in/via a capability signaling, their support of the length/duration of the event timer(s)/time window(s), e.g., that can be higher layer configured/provided in a CSI/beam resource setting or a CSI/beam resource set for the UE-initiated/event-driven beam reporting associated/linked/specific to a CSI/beam reporting setting or configuration e.g. higher layer configured/provided for the UE-initiated/event-driven beam reporting, that the UE could use/apply, e.g., for evaluating instance(s) of the event (e.g., the second event or Event-2 or the third event or Event-3 as specified/defined herein in the present disclosure), being greater than (or less than or equal to) a threshold, wherein the threshold value could be determined or identified based on or according to: (i) fixed value(s), e.g., greater than 1 symbol/slot, in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
The number of RS resource(s)—or the candidate/new beam RS resource(s) as specified/defined herein in the present disclosure—provided or configured in a CSI resource set in a CSI resource setting associated/linked to a CSI reporting setting for evaluating/declaring instance(s) of the event and/or evaluating, detecting or declaring the event according to or following those specified herein in the present disclosure, wherein the CSI resource set, the CSI resource setting and/or the CSI reporting setting could be provided or configured for the UE-initiated/event-driven beam reporting as specified/defined herein in the present disclosure, is greater than (or less than or equal to) a threshold, wherein the threshold value could be determined or identified based on or according to: (i) fixed value(s), e.g., greater than 1 symbol/slot, in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

According to or following those specified herein in the present disclosure, a UE could determine or identify a first set of one or more candidate/new beam RSs or RS resources to measure, assess or evaluate (e.g., to obtain the corresponding measurement result(s) including L1-RSRP(s)/L1-SINR(s)), e.g., for evaluating instance(s) of an event or evaluating or declaring an event according to or following those specified herein in the present disclosure, wherein the first set could correspond to a CSI resource set in a CSI resource setting associated/linked to a CSI reporting setting, and the CSI resource set, the CSI resource setting and/or the CSI reporting setting could be provided or configured for the UE-initiated/event-driven beam reporting as specified/defined herein in the present disclosure. In this case, to evaluate instance(s) of an event or to evaluate or declare an event according to or following those specified herein in the present disclosure, the UE could determine, identify or obtain the measurement result(s) including L1-RSRP(s)/L1-SINR(s) for candidate/new beam(s) by measuring, assessing or evaluating the beam qualities including L1-RSRP(s)/L1-SINR(s) of one or more of the one or more candidate/new beam RSs or RS resources in the first set having same value(s)—e.g., in terms of their RS or RS resource index(es) in their respective sets or their RS or RS resource ID(s)—as one or more of RS(s) or RS resource(s) in a second set, and/or quasi co-located (i.e., QCL'ed) with one or more of RS(s) or RS resource(s) in a second set. The UE could determine or identify the second set of one or more candidate/new beam RSs or RS resources according to or following one or more of:
In one example, the second set of RS(s) or RS resource(s) could be provided or configured or indicated to the UE, e.g., via higher layer RRC signaling(s)/parameter(s) and/or MAC CE command(s) and/or dynamic DCI based L1 signaling(s).
   For example, the second set of RS(s) or RS resource(s)—e.g., in terms/form of the corresponding RS/RS resource index(es) in the set and/or RS/RS resource ID(s)—could be provided or configured or indicated in higher layer parameter(s)/signaling(s) that provides necessary information and/or configurations and/or setting(s) for the UE-initiated/event-driven beam reporting. For instance, the higher layer parameter(s)/signaling(s) could correspond to TCI-State and/or UL-TCIState that configures or provides the indicated TCI state according to or following those specified herein in the present disclosure, wherein as specified/defined herein in the present disclosure the current beam RS(s) or RS resource(s) could be associated/specific to the indicated TCI state.
   For another example, the second set of RS(s) or RS resource(s)—e.g., in terms/form of the corresponding RS/RS resource index(es) in the set and/or RS/RS resource ID(s)—could be activated or updated or indicated or sub-selected by/in a MAC CE activation/deactivation or sub-selection or indication command. For instance, the MAC CE command could provide or indicate RS/RS resource index(es) and/or RS/RS resource ID(s) corresponding to the RS(s) or RS resource(s) in the second set. The MAC CE command herein could be a new MAC CE command or an existing MAC CE command, wherein the MAC CE command could correspond to or could be similarly designed according to the beam failure detection (BFD)-RS Indication MAC CE, SP CSI-RS/CSI-IM Resource Set Activation/Deactivation MAC CE, Aperiodic CSI Trigger State Subselection MAC CE and/or etc.
In another example, the second set of RS(s) or RS resource(s)—e.g., in terms/form of the corresponding RS/RS resource index(es) in the set and/or RS/RS resource ID(s)—could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to the reference signal(s) in one or more (or all) of the (activated) TCI-State(s) or UL-TCIState(s) activated or indicated or provided by/in a/the (unified) TCI state(s) activation/deactivation MAC CE command.
In another example, the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the reference signal(s) in one or more (or all) of the (activated) TCI-State(s) or UL-TCIState(s) activated or indicated or provided by/in a/the (unified) TCI state(s) activation/deactivation MAC CE command.

The UE could determine or identify whether the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set—expecting that the UE has already determined or identified the second set following or according to those specified herein in the present disclosure—according to or following those specified/defined herein in one or more examples herein according to or based on: (1) fixed rule(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on a corresponding UE's capability or capability signaling, and/or (3) UE's autonomous determination or selection, which could be further sent or transmitted to the network via various UL channels/signals, e.g., by/in part of the CSI/beam report and/or UE's capability signaling(s).
In one example, the UE (e.g., the UE 116) could be provided or configured or indicated by the network, e.g., in/by higher layer parameter(s)/signaling(s) that provides necessary information and/or configurations and/or setting(s) for the UE-initiated/event-driven beam reporting, an indicator to indicate to the UE whether the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein to evaluate instance(s) of an event or evaluate or declare an event according to or following those specified herein in the present disclosure.
   For example, the indicator could correspond to a higher layer parameter provided by ‘enableCandidateBeamRSSubset’; in this case, when/if ‘enableCandidateBeamRSSubset’ is provided/configured and/or set to ‘enabled’ or ‘on’, the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein; otherwise, i.e., when/if ‘enableCandidateBeamRSSubset’ is not provided/configured/present or is absent or is provided/configured/present but set to ‘disabled’ or ‘off’, the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure.
   For another example, the indicator could correspond to a one-bit flag indicator; in this case, when/if the one-bit flag indicator is provided/configured and/or set to ‘1’ (or ‘0’), the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following one or more examples described herein; otherwise, i.e., when/if the one-bit flag indicator is not provided/configured/present or is absent or is provided/configured/present but set to ‘0’ (or ‘1’), the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure.

For the design example as specified/defined herein in the present disclosure, the higher layer parameter(s)/signaling(s) TCI-State and/or UL-TCIState that configures or provides the indicated TCI state according to or following those specified herein in the present disclosure could provide or configure or comprise the indicator, wherein as specified/defined herein in the present disclosure the current beam RS(s) or RS resource(s) could be associated/specific to the indicated TCI state. For one or more examples described herein, the corresponding MAC CE activation, deactivation, indication or sub-selection command(s) could indicate, provide, comprise, include or contain the indicator (e.g., via a new field or by (repurposing) an existing field, e.g., an ‘R’ field).
In another example, when/if the number of activated TCI state(s)/TCI codepoint(s) in the (unified) TCI state(s) activation/deactivation MAC CE command is greater (or lower) than or equal to a threshold, the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined herein in one or more examples herein; otherwise, i.e., when/if the number of activated TCI state(s)/TCI codepoint(s) in the (unified) TCI state(s) activation/deactivation MAC CE command is lower (or greater) than or equal to the threshold, (i) the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure, or (ii) the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined in one or more examples described herein (i.e., rather than those specified/defined in one or more examples herein). The herein could be based on or according to network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. The value of the threshold defined herein could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
In another example, when/if the number of candidate/new beam RS(s) or RS resource(s) in the first set is greater (or lower) than or equal to a threshold, the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set according to or following those specified/defined in one or more examples herein; otherwise, i.e., when/if the number of candidate/new beam RS(s) or RS resource(s) in the first set is lower (or greater) than or equal to the threshold, the UE could only assess or evaluate or measure beam qualities including L1-RSRP(s)/L1-SINR(s) of one or more of the one or more candidate/new beam RSs or RS resources in the first set according to or following those specified herein in the present disclosure for evaluating instance(s) of an event or evaluating or declaring an event according to or following those specified herein in the present disclosure. The herein could be based on or according to network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling. The threshold value defined herein could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

In particular, when/if the UE has determined or identified that the UE could assess or evaluate or measure beam qualities including L1-RSRP(s)/L1-SINR(s) of one or more of the one or more candidate/new beam RSs or RS resources in the first set according to one or more of the one or more candidate/new beam RSs or RS resources in the second set—expecting that the UE has already determined or identified the second set following or according to those specified herein in the present disclosure—according to or following those specified/defined in one or more examples herein according to or following those specified herein in the present disclosure,
When/if the current serving beam RS(s) or RS resource(s) could correspond to NZP CSI-RS(s) or NZP CSI-RS resource(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is NZP CSI-RS(s), the UE could determine, identify or obtain the measurement result(s) including L1-RSRP(s)/L1-SINR(s) for candidate/new beam(s) by measuring, assessing or evaluating the beam qualities including L1-RSRP(s)/L1-SINR(s) of one or more of the one or more candidate/new beam RSs or RS resources in the first set that has/have same value(s)—e.g., in terms of their RS or RS resource index(es) in their respective sets or their RS or RS resource ID(s)—as one or more of the one or more candidate/new beam RSs or RS resources in the second set, and/or that is/are quasi co-located (i.e., QCL'ed) with one or more of the one or more candidate/new beam RSs or RS resources in the second set, to evaluate instance(s) of an event or evaluate, detect or declare an event according to or following those specified herein in the present disclosure, wherein the second set of RS(s) or RS resource(s)—e.g., in terms/form of the corresponding RS/RS resource index(es) in the set and/or RS/RS resource ID(s)—could correspond to the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to the reference signal(s) in one or more (or all) of the (activated) TCI-State(s) or UL-TCIState(s) activated or indicated or provided by/in a/the (unified) TCI state(s) activation/deactivation MAC CE command (i.e., following one or more examples described herein).
When/if the current serving beam RS(s) or RS resource(s) could correspond to SSB(s), and/or the UE could be configured or indicated or provided by the network, e.g., by/in higher layer RRC signaling(s)/parameter(s) and/or MAC CE command(s) and/or dynamic DCI based L1 signaling(s) based on or according to a corresponding UE's capability or capability signaling, an indicator enabling or configuring or indicating that the measurement RS(s) for evaluating instance(s) of an event or evaluating, detecting or declaring an event according to or following those specified herein in the present disclosure is SSB(s), the UE could determine, identify or obtain the measurement result(s) including L1-RSRP(s)/L1-SINR(s) for candidate/new beam(s) by measuring, assessing or evaluating the beam qualities including L1-RSRP(s)/L1-SINR(s) of one or more of the one or more candidate/new beam RSs or RS resources in the first set that has/have same value(s)—e.g., in terms of their RS or RS resource index(es) in their respective sets or their RS or RS resource ID(s)—as one or more of the one or more candidate/new beam RSs or RS resources in the second set, and/or that is/are quasi co-located (i.e., QCL'ed) with one or more of the one or more candidate/new beam RSs or RS resources in the second set, to evaluate instance(s) of an event or evaluate, detect or declare an event according to or following those specified herein in the present disclosure, wherein the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the (QCL source) RS(s) or RS resource(s) or RS resource index(es) in the RS set(s) provided or indicated in/by or associated with one or more (or all) of the (activated) TCI state(s)—each provided by TCI-State or UL-TCIState—activated or indicated or provided by/in a/the (unified) TCI state(s) activation/deactivation MAC CE command. Or equivalently, the second set of RS(s) or RS resource(s)—e.g., in terms/form of the corresponding RS/RS resource index(es) in the set and/or RS/RS resource ID(s)—could correspond to one or more (or all) of the SSB(s) that could be QCL'ed with the reference signal(s) in one or more (or all) of the (activated) TCI-State(s) or UL-TCIState(s) activated or indicated or provided by/in a/the (unified) TCI state(s) activation/deactivation MAC CE command (i.e., following one or more examples described herein).

Throughout the present disclosure, an indicated TCI state provided by TCI-State or UL-TCIState could also be replaced by or referred to as or equivalent to or could correspond to an indicated TCI state provided by CandidateTCI-State or CandidateTCI-UL-State, when/if applicable (e.g., when/if L1/L2 triggered mobility a.k.a. LTM is enabled or configured according to or following those specified herein in the present disclosure); furthermore, a TCI state—e.g., provided by TCI-State or UL-TCIState—indicated by/in a (unified) TCI state(s) activation/deactivation MAC CE command and/or by a TCI codepoint of a TCI field in a beam indication DCI of format 1_1/1_2 with or without DL assignment could also be replaced by or referred to as or equivalent to or could correspond to a TCI state—provided by CandidateTCI-State or CandidateTCI-UL-State—indicated in a LTM Cell Switch Command MAC CE, when/if applicable (e.g., when/if L1/L2 triggered mobility a.k.a. LTM is enabled or configured according to or following those specified herein in the present disclosure).

The second set of candidate/new beam RS(s) or RS resource(s) specified/defined herein in the present disclosure could also be associated, specific or linked to a/the CSI reporting setting provided or configured for the UE-initiated/event-driven beam reporting as specified/defined herein in the present disclosure. Furthermore, the design examples specified/defined/described herein throughout the present disclosure could also be applicable or extended to when a configured or activated or indicated TCI state only has TRS as the QCL RS and/or when only a TRS is provided or indicated or configured as a (QCL) RS in a configured or activated or indicated TCI state.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via dynamic grant (DG or Type1/Type2 configured grant (CG) PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s).

FIG. 10 illustrates an example method 1000 performed by a UE in a wireless communication system according to embodiments of the present disclosure. The method 1000 of FIG. 10 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1000 is for illustration only and other embodiments can be used without departing from the scope of the present disclosure.

The method 1000 begins with the UE receiving one or more TCI states (1010). In various embodiments, the one or more TCI states are activated in a TCI states activation or deactivation MAC CE command. The UE then receives information related to an event in a CSI report configuration for UEI reporting (1020). The UE then determines a first RS resource based on the one or more TCI states and the information (1030). In various embodiments, the information includes a value Q the first RS resource has a Q-th highest measured L1-RSRP among all RS resources associated with the one or more TCI states. For example, when a RS resource is specific to a TCI state, the RS resource corresponds to a NZP CSI-RS resource provided in a higher layer parameter TCI-State that configures the TCI state, or a SSB quasi co-located with the NZP CSI-RS resource provided in the higher layer parameter TCI-State that configures the TCI state.

The UE then determines one or more second RS resources based on the CSI report configuration (1040). In various embodiments, the one or more second RS resources are provided in the CSI report configuration by a higher layer parameter CSI-SSB-ResourceSet comprising one or more SSBs or a higher layer parameter NZP-CSI-RS-ResourceSet comprising one or more NZP CSI-RS resources.

The UE then monitors TOs of the first RS resource and the one or more second RS resources (1050). The UE then determines the event based on L1-RSRPs of the TOs and the information (1060). In various embodiments, the information comprises a threshold and, when a measured L1-RSRP of a TO of a second RS resource is greater than a measured L1-RSRP of a TO of the first RS resource by a configured threshold, an event instance for the second RS resource is determined. For example, the event is determined when a number of determined event instances for the second RS resource are greater than a configured number within a configured time window length.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive one or more transmission configuration indication (TCI) states; and
receive information related to an event in a channel state information (CSI) report configuration for UE-initiated (UEI) reporting; and
a processor operably coupled with the transceiver, the processor configured to:
determine a first reference signal (RS) resource based on the one or more TCI states and the information; and
determine one or more second RS resources based on the CSI report configuration,
wherein the transceiver is further configured to monitor transmission occasions (TOs) of the first RS resource and the one or more second RS resources, and
wherein the processor is further configured to determine the event based on (i) layer-1 reference signal received powers (L1-RSRPs) of the TOs and (ii) the information.

2. The UE of claim 1, wherein the one or more TCI states are activated in a TCI states activation or deactivation medium access control (MAC) control element (CE) command.

3. The UE of claim 1, wherein:
the information includes a value Q, and
the first RS resource has a Q-th highest measured L1-RSRP among all RS resources associated with the one or more TCI states.

4. The UE of claim 3, wherein, when a RS resource is specific to a TCI state, the RS resource corresponds to:
a non-zero-power (NZP) CSI-RS resource provided in a higher layer parameter TCI-State that configures the TCI state, or
a synchronization signal/physical broadcast channel block (SSB) quasi co-located with the NZP CSI-RS resource provided in the higher layer parameter TCI-State that configures the TCI state.

5. The UE of claim 1, wherein the one or more second RS resources are provided in the CSI report configuration by:
a higher layer parameter CSI-SSB-ResourceSet comprising one or more synchronization signal/physical broadcast channel blocks (SSBs), or
a higher layer parameter NZP-CSI-RS-ResourceSet comprising one or more non-zero-power (NZP) CSI-RS resources.

6. The UE of claim 1, wherein:
the information comprises a threshold, and
when a measured L1-RSRP of a TO of a second RS resource is greater than a measured L1-RSRP of a TO of the first RS resource by a configured threshold, an event instance for the second RS resource is determined.

7. The UE of claim 6, wherein, when a number of determined event instances for the second RS resource are greater than a configured number within a configured time window length, the event is determined.

8. A base station (BS), comprising:
a processor; and
a transceiver operably coupled with the processor, the transceiver configured to:
transmit one or more transmission configuration indication (TCI) states;
transmit information related to an event in a channel state information (CSI) report configuration for UE-initiated (UEI) reporting; and
transmit on transmission occasions (TOs) of a first reference signal (RS) resource and one or more second RS resources,
wherein the one or more TCI states and the information indicate the first RS resource,
wherein the CSI report configuration indicate the one or more second RS resources, and
wherein the event is based on (i) layer-1 reference signal received powers (L1-RSRPs) of the TOs and (ii) the information.

9. The BS of claim 8, wherein the one or more TCI states are activated in a TCI states activation or deactivation medium access control (MAC) control element (CE) command.

10. The BS of claim 8, wherein:
the information includes a value Q, and
the first RS resource has a Q-th highest measured L1-RSRP among all RS resources associated with the one or more TCI states.

11. The BS of claim 10, wherein, when a RS resource is specific to a TCI state, the RS resource corresponds to:
a non-zero-power (NZP) CSI-RS resource provided in a higher layer parameter TCI-State that configures the TCI state, or
a synchronization signal/physical broadcast channel block (SSB) quasi co-located with the NZP CSI-RS resource provided in the higher layer parameter TCI-State that configures the TCI state.

12. The BS of claim 8, wherein the one or more second RS resources are provided in the CSI report configuration by:
a higher layer parameter CSI-SSB-ResourceSet comprising one or more synchronization signal/physical broadcast channel blocks (SSBs), or
a higher layer parameter NZP-CSI-RS-ResourceSet comprising one or more non-zero-power (NZP) CSI-RS resources.

13. The BS of claim 8, wherein:
the information comprises a threshold, and
when a measured L1-RSRP of a TO of a second RS resource is greater than a measured L1-RSRP of a TO of the first RS resource by a configured threshold, an event instance for the second RS resource is determined.

14. The BS of claim 13, wherein, when a number of determined event instances for the second RS resource are greater than a configured number within a configured time window length, the event is determined.

15. A method performed by a user equipment (UE), the method comprising:
receiving one or more transmission configuration indication (TCI) states;
receiving information related to an event in a channel state information (CSI) report configuration for UE-initiated (UEI) reporting;
determining a first reference signal (RS) resource based on the one or more TCI states and the information;
determining one or more second RS resources based on the CSI report configuration;
monitoring transmission occasions (TOs) of the first RS resource and the one or more second RS resources; and
determining the event based on (i) layer-1 reference signal received powers (L1-RSRPs) of the TOs and (ii) the information.

16. The method of claim 15, wherein the one or more TCI states are activated in a TCI states activation or deactivation medium access control (MAC) control element (CE) command.

17. The method of claim 15, wherein:
the information includes a value Q, and
the first RS resource has a Q-th highest measured L1-RSRP among all RS resources associated with the one or more TCI states.

18. The method of claim 17, wherein, when a RS resource is specific to a TCI state, the RS resource corresponds to:
a non-zero-power (NZP) CSI-RS resource provided in a higher layer parameter TCI-State that configures the TCI state, or
a synchronization signal/physical broadcast channel block (SSB) quasi co-located with the NZP CSI-RS resource provided in the higher layer parameter TCI-State that configures the TCI state.

19. The method of claim 15, wherein the one or more second RS resources are provided in the CSI report configuration by:
a higher layer parameter CSI-SSB-ResourceSet comprising one or more synchronization signal/physical broadcast channel blocks (SSBs), or
a higher layer parameter NZP-CSI-RS-ResourceSet comprising one or more non-zero-power (NZP) CSI-RS resources.

20. The method of claim 15, wherein:
the information comprises a threshold, and
when a measured L1-RSRP of a TO of a second RS resource is greater than a measured L1-RSRP of a TO of the first RS resource by a configured threshold, an event instance for the second RS resource is determined.
